(19) United States
(12) Patent Application Publication
(10) Pub. No.: US 2026/0034791 A1
(43) Pub. Date: Feb. 5, 2026

(54) INK JET RECORDING METHOD AND INK JET RECORDING APPARATUS

(71) Applicant: CANON KABUSHIKI KAISHA, Tokyo (JP)

(72) Inventors: YOSHIYUKI KANEKO, Kanagawa (JP); KAZUHIKO ARAKI, Kanagawa (JP); YUKI NISHINO, Tokyo (JP); YUKO NISHIWAKI, Tokyo (JP); AIKO MASADA, Tokyo (JP); SAYOKO NAGASHIMA, Kanagawa (JP); SATOSHI TAKEBAYASHI, Tokyo (JP)

(21) Appl. No.: 19/276,291

(22) Filed: Jul. 22, 2025

(30) Foreign Application Priority Data
Jul. 31, 2024 (JP) 2024-124151
Jul. 31, 2024 (JP) 2024-124152
Jun. 16, 2025 (JP) 2025-100390

(51) Int. Cl. B41J 2/175; B41J 2/19

(52) U.S. Cl. CPC B41J 2/175; B41J 2/19

(57) ABSTRACT

An ink jet recording method of recording an image through use of an ink jet recording apparatus includes a recording head including: an ejection orifice configured to eject an aqueous ink; a pressure chamber in communication with the ejection orifice; an ejection element, which is arranged in the pressure chamber, and which is configured to generate energy for ejecting the aqueous ink from the ejection orifice; a liquid retention chamber that can supply the aqueous ink to the pressure chamber; a decompression chamber, which is arranged adjacent to the liquid retention chamber, and which is configured to be capable of decompressing an inside of the liquid retention chamber; and a gas permeable membrane having a thickness of 0.01 mm or more and arranged at a boundary between the liquid retention chamber and the decompression chamber.

### BACKGROUND

### Field of the Technology

The present disclosure relates to an ink jet recording method and an ink jet recording apparatus.

### Description of the Related Art

According to an ink jet recording method, images, such as a photograph and a document, can be recorded on various recording media. In addition, there have been proposed various inks in accordance with applications, such as an ink suitable for recording a photo-quality image on glossy paper and an ink suitable for recording a document or the like on plain paper.

When an ink jet recording apparatus is used, a bubble may be mixed into an ink flow path at the time of replacement of an ink storage portion, such as an ink cartridge or an ink storage bag, or a recording head. When the mixed bubble enters a pressure chamber of the recording head, the pressure for ejecting an ink becomes insufficient, and hence ink ejection performance may be influenced. In addition, when the bubble remains in the ink flow path of the recording head, it is also assumed that the remaining bubble may expand depending on a change in external environment, for example, an increase in temperature of an installation environment, causing a phenomenon such as leakage of the ink to be liable to occur. Thus, in order to stably use the recording apparatus and the recording head, it is preferable that the recording head be configured to discharge the bubble having entered therein to the outside.

When the bubble having entered the inside of the recording head is increased after the recording apparatus is left for a certain period of time, a suction recovery process involving sucking the bubble through an ejection orifice together with the ink to restore the state is performed. When the amount of the mixed bubble is large, the suction recovery process is required to be performed a plurality of times. In the suction recovery process, a large amount of an ink is sucked, and hence the amount of an ink to be discharged without being used for recording is increased along with an increase in the number of processes or an increase in the amount of an ink to be sucked in one process. As a result, the amount (the number of sheets) of an image that can be recorded with a certain amount of an ink is decreased, causing a problem of a decrease in productivity.

As a technology for taking countermeasures against a bubble, there has been proposed a recording apparatus in which a deaeration unit including a hollow fiber module or a filter that traps a bubble is introduced into a path that supplies an ink from an ink storage portion to a recording head (Japanese Patent Laid-Open No. 2015-058544 and Japanese Patent Laid-Open No. 2013-223980). Meanwhile, there has been proposed a recording apparatus in which a deaerator including a partition formed of a hollow fiber membrane is incorporated into the inside of a recording head (Japanese Patent Laid-Open No. 2011-173428). In addition, based on the recognition of a problem in that the use of a membrane causes the insufficiency of strength, there has been proposed a liquid jetting apparatus that utilizes a gas permeable partition wall integrally molded with a liquid retention chamber instead of a membrane to decompress a gas collecting unit to collect a gas (Japanese Patent Laid-Open No. 2008-173961).

### SUMMARY

The inventors of the present disclosure have investigated the characteristics of the apparatuses proposed in Japanese Patent Laid-Open No. 2015-058544, Japanese Patent Laid-Open No. 2013-223980, Japanese Patent Laid-Open No. 2011-173428 and Japanese Patent Laid-Open No. 2008-173961. The apparatus proposed in Japanese Patent Laid-Open No. 2015-058544 had a problem in that the apparatus was complicated in configuration and increased in size while the state of the recording head after being left for a certain period of time was able to be restored by a small number of suctions. In addition, in the apparatus proposed in Japanese Patent Laid-Open No. 2013-223980, a bubble was not able to be sufficiently trapped, and ejection failure sometimes occurred due to the bubble having flowed into an ejection unit in an amount more than the allowable amount without being able to be trapped. In addition, in the apparatus proposed in Japanese Patent Laid-Open No. 2011-173428, deaeration was insufficient, and ejection failure sometimes occurred. In addition, even when the gas permeable partition wall proposed in Japanese Patent Laid-Open No. 2008-173961 was used, the effect of discharging a bubble was insufficient, and hence ejection failure sometimes occurred. Thus, it has been found that, in order to restore the state of the recording head to the state in which normal ejection can be performed, the number of suctions or the amount of an ink to be sucked is required to be increased.

Accordingly, the present disclosure is directed to the provision of an ink jet recording method excellent in suction recoverability and ejection stability of an ink. In addition, the present disclosure is also directed to the provision of an ink jet recording apparatus that is to be used in the ink jet recording method.

That is, according to the present disclosure, there is provided an ink jet recording method of recording an image through use of an ink jet recording apparatus including a recording head, the recording head including: an ejection orifice configured to eject an aqueous ink; a pressure chamber in communication with the ejection orifice; an ejection element, which is arranged in the pressure chamber, and which is configured to generate energy for ejecting the aqueous ink from the ejection orifice; a liquid retention chamber that can supply the aqueous ink to the pressure chamber; a decompression chamber, which is arranged adjacent to the liquid retention chamber, and which is configured to be capable of decompressing an inside of the liquid retention chamber; and a gas permeable membrane having a thickness of 0.01 mm or more and arranged at a boundary between the liquid retention chamber and the decompression chamber. The ink jet recording method includes applying the aqueous ink ejected from the ejection orifice to a recording medium. A surface tension γᵢ (mN/m) of the aqueous ink at 25° C. and a surface energy γₘ (mN/m) of the gas permeable membrane satisfy a relationship of the following formula (1).

$${γ}_{i} - {γ}_{m} \leq 11 \qquad ( 1 )$$

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view for schematically illustrating an ink jet recording apparatus according to one embodiment of the present disclosure.

FIG. 2 is a view for schematically illustrating an example of a recording unit.

FIG. 3 is a schematic diagram for illustrating an example of a flow path of an ink supply unit.

FIG. 4 is an explanatory schematic diagram for illustrating an example of a bubble extraction decompression operation.

FIG. 5 is an exploded perspective view for illustrating an example of a recording head.

FIG. 6 is a vertical sectional view for illustrating an example of a circulation path.

FIG. 7 is a schematic view for illustrating an example of a bubble extraction unit.

FIG. 8 is a view for schematically illustrating a first configuration example of an ink path.

FIG. 9 is a view for schematically illustrating a first modification example of the circulation path.

FIG. 10 is a view for schematically illustrating a second configuration example of the ink path.

FIG. 11 is a view for schematically illustrating a second modification example of the circulation path.

### DESCRIPTION OF THE EMBODIMENTS

The present disclosure is described in more detail below by way of exemplary embodiments. In the present disclosure, when a compound is a salt, the salt is present as dissociated ions in an ink, but the expression “contain a salt” is used for convenience. In addition, an aqueous ink for ink jet is sometimes referred to simply as “ink”. Physical property values are values at a normal temperature (25° C.) and a normal pressure (1 atm), unless otherwise stated. The descriptions “(meth)acrylic acid” and “(meth)acrylate” refer to “acrylic acid or methacrylic acid” and “acrylate or methacrylate”, respectively.

The inventors of the present disclosure have investigated the ejection characteristics of an aqueous ink to be ejected from a recording head when an image is recorded on a recording medium through use of an ink jet recording apparatus. Specifically, an ink jet recording apparatus including a recording head was prepared, the recording head including: a liquid retention chamber; a decompression chamber arranged adjacent to the liquid retention chamber and configured to be capable of decompressing an inside of the liquid retention chamber; and a gas permeable membrane arranged at a boundary between the liquid retention chamber and the decompression chamber. Next, in order to reproduce the state obtained after the recording apparatus was left for a certain period of time, the liquid retention chamber was filled with the maximum amount of air that could be trapped and was left for 5 days. Then, the decompression chamber was decompressed, and the air in the liquid retention chamber was transferred to the decompression chamber through the gas permeable membrane. After that, the normal suction recovery operation of performing suction from an ejection orifice was performed to check the ejection characteristics of an ink. As a result, it was found that the phenomena such as the occurrence of non-ejection and irregular ejection, that is, ejection defects occurred, and hence the ejection characteristics of an ink were decreased. An ink flow path of the ejection orifice in which the irregular ejection had occurred was observed in detail, and it was recognized that a bubble was present in the ink flow path in communication with the ejection orifice. That is, it was found that the discharge of a bubble was insufficient in the decompression and the normal suction recovery operation.

When an ink is to be ejected after the recording apparatus is left for a certain period of time, in order to discharge a bubble generated in an ink in the ink flow path from the liquid retention chamber to the ejection orifice, it is required to perform a suction recovery process involving sucking part of the ink from the ejection orifice to discharge the bubble. However, when the trapped air is present in the liquid retention chamber, the phenomenon in which, for example, a bubble generated by the air in the liquid retention chamber flows into the ink flow path occurs due to the suction recovery process. Although such inflow of the bubble into the ink flow path can be avoided by increasing the number of suction recovery processes, recording cannot be performed during the suction recovery process, and hence the productivity per unit time is decreased. In view of the foregoing, the air trapped in the liquid retention chamber is transferred to the decompression chamber through the gas permeable membrane by arranging the decompression chamber adjacent to the liquid retention chamber through intermediation of the gas permeable membrane having a thickness of 0.10 mm or more and decompressing the decompression chamber. As a result, the bubble in the ink within the ink flow path from the liquid retention chamber to the ejection orifice can be discharged by the minimum suction recovery operation. When the thickness of the gas permeable membrane is less than 0.01 mm, the strength of the membrane is not sufficient, and hence the decompression cannot be strongly performed. As a result, the bubble in the ink within the ink flow path cannot be sufficiently removed, and thus the ejection stability of the ink cannot be improved.

When the liquid retention chamber is decompressed through the gas permeable membrane having a thickness of 0.01 mm or more, the bubble retained in the liquid retention chamber is caused to burst, and hence air is removed. Here, it is known that the internal pressure is higher when the size of the bubble is smaller, and a smaller bubble having a higher internal pressure is caused to burst more efficiently to be removed, under reduced pressure. As a result of the investigations made by the inventors of the present disclosure, it has been found that, in order to generate such small bubble, it is effective to enhance the wettability between the ink and the gas permeable membrane. Thus, the inventors of the present disclosure have reached the present disclosure. In order to efficiently remove a bubble, it is preferable to decrease the surface tension of the ink and to increase the surface energy of the gas permeable membrane. Specifically, the surface tension γᵢ (mN/m) of the ink at 25° C. and the surface energy γₘ (mN/m) of the gas permeable membrane are designed so as to satisfy the relationship of the following formula (1).

$${γ}_{i} - {γ}_{m} \leq 11 \qquad ( 1 )$$

In general, it is known that, when a liquid has a lower surface tension, the wettability thereof to an object is increased. In addition, it is known that, when a solid has higher surface energy, the wettability thereof to a liquid is increased. Thus, it is conceived that the selection of an ink and a gas permeable membrane having a thickness of 0.01 mm or more, which are mutually wettable, enables the effective removal of a bubble in the ink within the ink flow path, and hence the ejection stability of the ink is improved.

### <Ink Jet Recording Method and Ink Jet Recording Apparatus>

The ink jet recording method of the present disclosure is an ink jet recording method of recording an image through use of an ink jet recording apparatus including a predetermined recording head. The ink jet recording method includes applying an aqueous ink ejected from an ejection orifice of the recording head to a recording medium. The recording head includes an ejection orifice that ejects an aqueous ink, a pressure chamber that is in communication with the ejection orifice, an ejection element, a liquid retention chamber that can supply the aqueous ink to the pressure chamber, a decompression chamber and a gas permeable membrane having a thickness of 0.01 mm or more and arranged at a boundary between the liquid retention chamber and the decompression chamber. The ejection element is a portion which is arranged in the pressure chamber, and which generates energy for ejecting the aqueous ink from the ejection orifice. The decompression chamber is a portion which is arranged adjacent to the liquid retention chamber, and which is configured to be capable of decompressing an inside of the liquid retention chamber. Then, the surface tension γᵢ (mN/m) of the aqueous ink at 25° C. and the surface energy γₘ (mN/m) of the gas permeable membrane satisfy a relationship of the following formula (1).

$${γ}_{i} - {γ}_{m} \leq 11 \qquad ( 1 )$$

In addition, the ink jet recording apparatus of the present disclosure is an ink jet recording apparatus including a predetermined recording head. The recording head includes an ejection orifice that ejects an aqueous ink, a pressure chamber that is in communication with the ejection orifice, an ejection element, a liquid retention chamber that can supply the aqueous ink to the pressure chamber, a decompression chamber and a gas permeable membrane having a thickness of 0.01 mm or more and arranged at a boundary between the liquid retention chamber and the decompression chamber. The ejection element is a portion which is arranged in the pressure chamber, and which generates energy for ejecting the aqueous ink from the ejection orifice. The decompression chamber is a portion which is arranged adjacent to the liquid retention chamber, and which is configured to be capable of decompressing an inside of the liquid retention chamber. Then, the surface tension γᵢ (mN/m) of the aqueous ink at 25° C. and the surface energy γₘ (mN/m) of the gas permeable membrane satisfy a relationship of the following formula (1).

$${γ}_{i} - {γ}_{m} \leq 11 \qquad ( 1 )$$

### (Ink Jet Recording Apparatus)

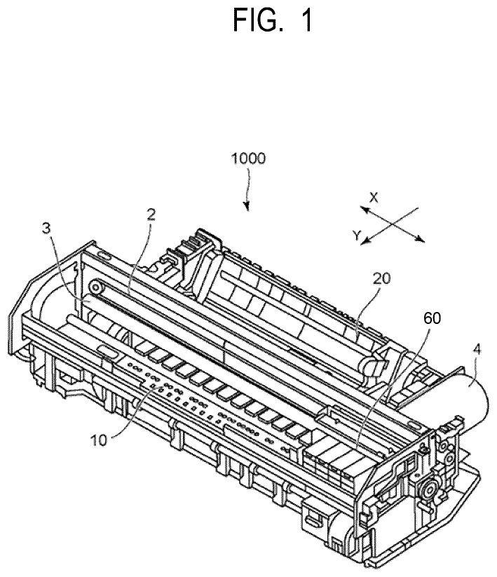

FIG. 1 is a perspective view for schematically illustrating an ink jet recording apparatus according to one embodiment of the present disclosure. As illustrated in FIG. 1, a feed unit 20 of a recording apparatus 1000 is capable of having a plurality of recording media mounted thereon and feeds the recording medium by a feed roller (not shown). As the recording medium, in addition to cut paper obtained by cutting paper to a predetermined size, roll paper may also be used. The recording medium fed by the feed unit 20 is conveyed in the Y direction (conveyance direction) by a conveyance unit including a conveyance roller and moved to a recording position opposed to a recording head that ejects an ink. A carriage 60 has a recording head 1 mounted thereon and is driven by a carriage motor 4 to perform reciprocal scanning in the X direction (main scanning direction) that intersects with the Y direction along a guide shaft 3 via a timing belt 2.

When an image corresponding to a unit area is recorded by the movement of the carriage 60 in the X direction and the ejection operation of ejecting an ink by the recording head 1, the recording medium is conveyed in the Y direction by the conveyance unit. The unit area to be set may be freely selected from, for example, “one band” recordable by the arrangement width of an ejection orifice array arranged along the Y direction in the recording head 1 and the one movement in the X direction of the recording head 1 and “one pixel” corresponding to the resolution of the recording head. In a serial type, an image can be recorded over the entire recording medium by the recording operation involving repeating the ejection operation of ejecting an ink corresponding to one band and the intermittent conveyance operation of conveying the recording medium. In this embodiment, the X direction and the Y direction are orthogonal to each other.

### [Recording Medium]

Any recording medium may be used as the recording medium. For example, recording media having ink absorbability (permeability) may be used. Examples of such recording media include: a recording medium free of a coating layer, such as plain paper, uncoated paper or synthetic paper; and a recording medium including a coating layer, such as recording paper, glossy paper or art paper. In addition, a recording medium that does not have permeability like a film or a sheet formed from a resin material, such as polyvinyl chloride (PVC) or polyethylene terephthalate (PET), may be used.

### [Recording Unit]

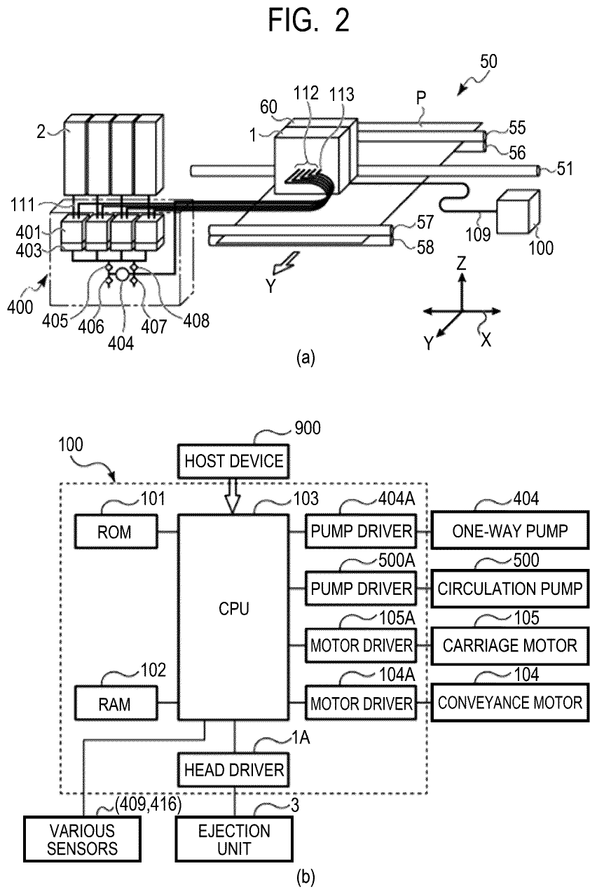

FIG. 2 is a view for schematically illustrating an example of a recording unit and is an enlarged view of the recording head in the recording unit and a surrounding area thereof. First, the schematic configuration of a recording unit 50 is described with reference to FIG. 2. Part (a) of FIG. 2 is a perspective view for schematically illustrating the recording unit 50 that allows the recording head 1 to be mounted thereon. The recording unit 50 forms a serial-type ink jet recording apparatus that perform recording on the recording medium P by ejecting an ink while causing the recording head 1 to perform scanning.

The recording head 1 is mounted on the carriage 60. The carriage 60 moves back and forth in a main scanning direction (X direction) along a guide shaft 51. The recording medium P is conveyed in a sub-scanning direction (Y direction) that intersects with (in this example, is orthogonal to) the main scanning direction with upstream conveyance rollers 55 and 56 and downstream conveyance rollers 57 and 58. In each of the figures referred to below, a Z direction indicates a vertical direction and intersects with (in this example, is orthogonal to) an X-Y plane defined by the X direction and the Y direction. The recording head 1 is configured to be detachable from and attachable onto the carriage 60 by a user.

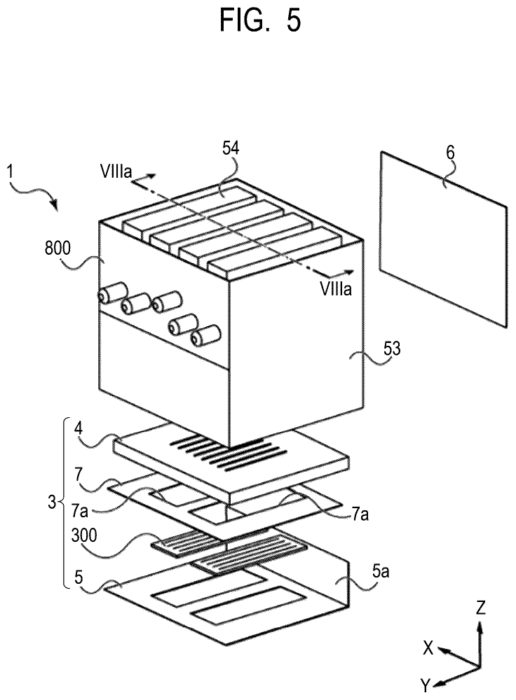

The recording head 1 is configured so as to include a circulation unit 54 (see FIG. 5) described later and an ejection unit 3 (see FIG. 5). Although the specific configuration is described later, the ejection unit 3 includes a plurality of ejection orifices and an energy generating element (hereinafter referred to as “ejection element”) that generates ejection energy for ejecting an ink from each of the ejection orifices.

In addition, the recording unit 50 includes an ink storage portion 2, which servs as an ink supply source, and an ink supply unit 400. The ink stored in the ink storage portion 2 is supplied to the recording head 1 through a first supply path 111 and a second supply path 112 by the ink supply unit 400. In addition, a gas, such as a bubble, generated in the recording head 1 is discharged to the outside of the recording head 1 through a third air flow path 113 by the ink supply unit 400.

The recording unit 50 records a predetermined image on the recording medium P by repeatedly performing record scanning and conveyance operation. In the record scanning, the recording head 1 mounted on the carriage 60 performs recording by ejecting an ink while moving in the main scanning direction. In the conveyance operation, the recording medium P is conveyed in the sub-scanning direction. The recording head 1 can eject four kinds of inks including black (K), cyan (C), magenta (M) and yellow (Y) and can record a full-color image with those inks. However, the inks that can be ejected from the recording head 1 are not limited to the above-mentioned four kinds of inks. The present disclosure may also be applied to a recording head that ejects other kinds of inks. That is, the kinds and the number of inks ejected from the recording head are not limited. For example, one kind of ink or two or more kinds of inks may be ejected from the recording head. In addition, an ink containing no coloring material (clear ink) or a reaction liquid containing a reagent that reacts with an ink may also be used as an ink.

In addition, the recording unit 50 includes a control unit 100 and a cap member (not shown) that can cover an ejection orifice surface on which an ejection orifice of the recording head 1 is formed. The cap member is arranged at a position apart in the X direction from a conveyance path of the recording medium P in the recording unit 50. The cap member covers the ejection orifice surface of the recording head 1 at the time of a non-recording operation, and is used for, for example, suppressing drying of an ink in the vicinity of the ejection orifice, protecting the recording head and performing an operation of sucking an ink from the ejection orifice. A signal output from the control unit 100 is transmitted to the recording head 1 and the like through a signal line 109.

Part (b) of FIG. 2 is a block diagram for illustrating a control system for the recording unit 50. The control unit 100 of the recording unit 50 includes a CPU 103, a RAM 102, a ROM 101, a head driver 1A, motor drivers 104A and 105A and pump drivers 404A and 500A. The CPU 103 functions as a control unit that controls the operation of each part of the recording unit 50 based on a program, such as a processing procedure, stored in the ROM 101. The RAM 102 is used as a work area when the CPU 103 executes processing. The CPU 103 receives image data from a host device 900 located outside the recording unit 50 to control the head driver 1A and controls the drive of an ejection element arranged in the ejection unit 3. In addition, the CPU 103 also controls the drivers of various actuators arranged in the recording unit. For example, the CPU 103 controls the motor driver 104A that drives a conveyance motor 104 for conveying the recording medium P. The CPU 103 controls the motor driver 105A that drives a carriage motor 105 for moving the carriage 60. The CPU 103 controls the pump driver 500A that drives a circulation pump 500. The CPU 103 controls the pump driver 404A that drives a one-way pump 404 described later. In addition, the control unit 100 receives signals output from various sensors, such as a volume sensor, a pressure sensor 409 and a liquid sensor 416. In part (b) of FIG. 2, illustration is given of a mode in which processing involving receiving image data from the host device 900 is performed, but processing may also be performed in the recording unit 50 independently of the data from the host device 900.

### [Ink Supply Unit]

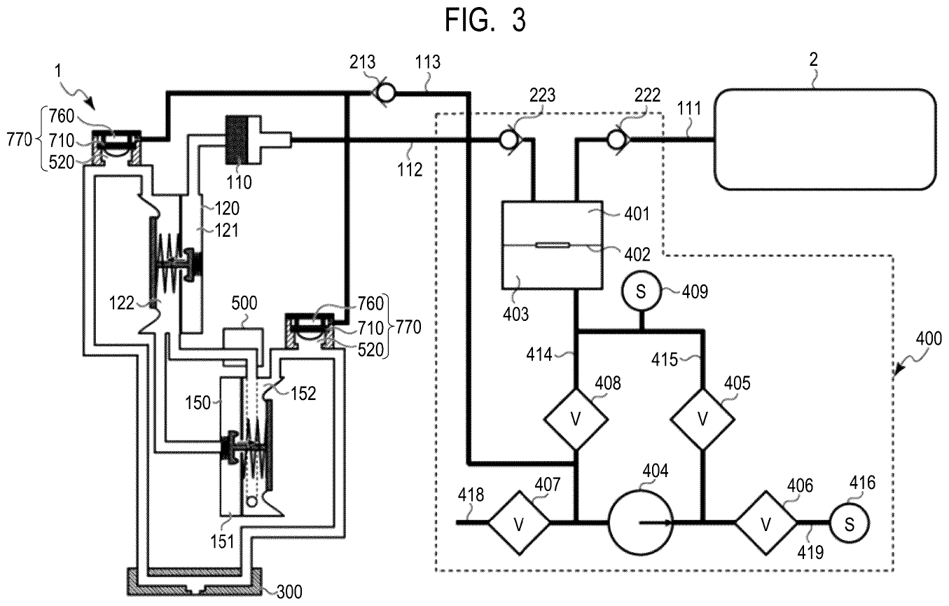

FIG. 3 is a schematic diagram for illustrating an example of a flow path of the ink supply unit. The ink supply unit 400 illustrated in FIG. 3 includes an intermediate storage portion 401 that temporarily stores an ink supplied from the ink storage portion 2 configured to be attachable onto and detachable from the recording unit 50, through the first supply path 111. A first check valve 222 is arranged in the middle of the first supply path 111, and the first check valve 222 regulates the backflow of an ink from the intermediate storage portion 401 to the ink storage portion 2. At least one surface of the intermediate storage portion 401 is formed of a flexible membrane 402, and the volume of the intermediate storage portion 401 can be changed. A volume sensor (not shown) is arranged in the intermediate storage portion 401. The volume sensor can detect the volume of the intermediate storage portion 401 by measuring the displacement of the flexible membrane 402. Based on the detection results of the volume of the intermediate storage portion 401 by the volume sensor, the amount of the ink in the intermediate storage portion 401 can be estimated. The amount of the ink in the intermediate storage portion 401 may be estimated based on the detection results of the volume of the intermediate storage portion 401 by the volume sensor and the amount of an ink consumed by, for example, formation of an image on the recording medium and suction of an ink from the cap member.

The intermediate storage portion 401 is in contact with a pressure chamber filled with air through intermediation of the flexible membrane 402. The pressure chamber of the intermediate storage portion 401 is hereinafter referred to as “intermediate pressure chamber 403”. The pressure of the ink stored in the intermediate storage portion 401 can be changed by changing the pressure of a gas (air) in the intermediate pressure chamber 403. The ink stored in the intermediate storage portion 401 is supplied to the recording head 1 through the second supply path 112 connected to the intermediate storage portion 401 and a filter 110 of the recording head 1. A second check valve 223 is arranged in the middle of the second supply path 112, and the second check valve 223 regulates the backflow of an ink from the recording head 1 to the intermediate storage portion 401. The ink supply unit 400 includes the one-way pump 404 driven by the pump driver 404A. The one-way pump 404 is configured through use of, for example, a diaphragm pump and can suck and discharge air in one direction through the drive by the pump driver 404A.

The intermediate pressure chamber 403 and a suction side of the one-way pump 404 are connected to each other through a first air flow path 414. A first on-off valve 408 is arranged in the middle of the first air flow path 414, and the first air flow path 414 can be switched between communication and closing by an opening-closing operation of the first on-off valve 408. In the first air flow path 414, a first branched air flow path 418, which is branched between the first on-off valve 408 and the one-way pump 404, and one end of which is in communication with the atmosphere, is arranged. In the first branched air flow path 418, a third on-off valve 407 is arranged, and the suction side of the one-way pump 404 can be switched between sealing and opening to the atmosphere by an opening-closing operation of the third on-off valve 407.

In addition, the intermediate pressure chamber 403 and a jetting side of the one-way pump 404 are connected to each other through a second air flow path 415. A second on-off valve 405 is arranged in the middle of the second air flow path 415, and the second air flow path 415 can be switched between communication and closing by an opening-closing operation of the second on-off valve 405. In the second air flow path 415, a second branched air flow path 419, which is branched between the second on-off valve 405 and the one-way pump 404, and one end of which is in communication with the atmosphere, is arranged. In the second branched air flow path 419, a fourth on-off valve 406 is arranged, and the jetting side of the one-way pump 404 can be switched between sealing and opening to the atmosphere by an opening-closing operation of the fourth on-off valve 406. A liquid sensor 416 is arranged in an end portion opened to the atmosphere in the second branched air flow path 419. The liquid sensor 416 can detect an ink that has entered the air flow path. A pressure sensor 409 is arranged at any one of the positions that are in communication with the intermediate pressure chamber 403. The pressure sensor 409 can detect the pressure of the gas (air) in the intermediate pressure chamber 403. The one-way pump 404 and a decompression chamber 760 of a bubble extraction unit 770 in the recording head 1 are connected to each other through the third air flow path 113. A third check valve 213 is arranged in the middle of the third air flow path 113, and the third check valve 213 regulates the backflow of a gas (air) from the ink supply unit 400 to the decompression chamber 760. In FIG. 3, a first valve chamber 121, a second valve chamber 151 and a second pressure control chamber 152 are illustrated.

In order to record an image on the recording medium P, the ink supply unit 400 mainly performs four operations (pressure chamber pressurization operation, pressurization maintenance operation, ink replenishment operation and bubble extraction decompression operation). Based on the detection results by the volume sensor (not shown), the pressure sensor 409 and the like, the CPU 103 controls the one-way pump 404 and the first to fourth on-off valves, to thereby perform the pressure chamber pressurization operation, the pressurization maintenance operation, the ink replenishment operation and the bubble extraction decompression operation.

### [Bubble Extraction Decompression Operation]

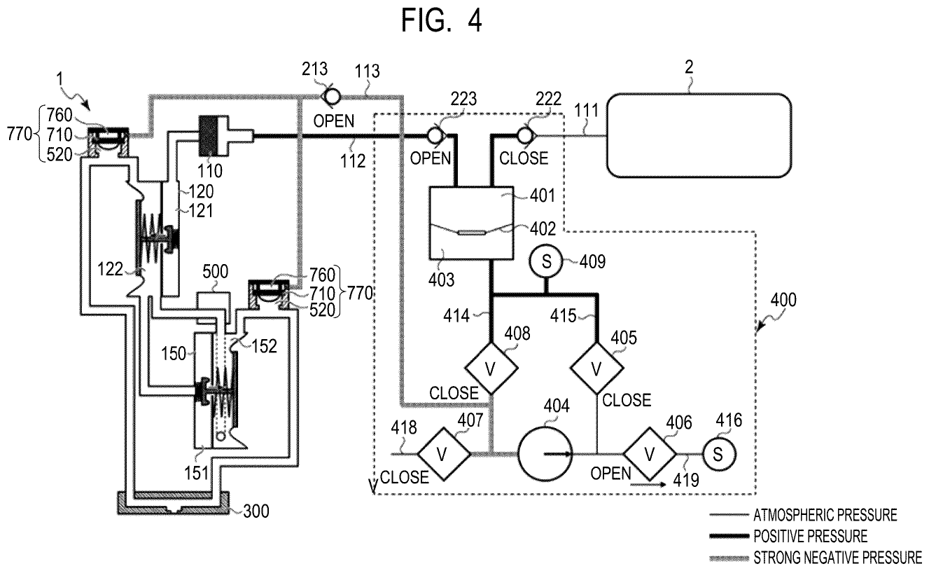

FIG. 4 is an explanatory schematic diagram for illustrating an example of a bubble extraction decompression operation. The bubble extraction decompression operation is an operation of decreasing the pressure in the decompression chamber 760. The moving speed of a gas from a bubble retention chamber 520 of the bubble extraction unit 770 to the decompression chamber 760 through a gas permeable membrane 710 in the recording head 1 is proportional to the difference between the pressure in the bubble retention chamber 520 and the pressure in the decompression chamber 760. Thus, it is preferable that the pressure in the decompression chamber 760 be maintained at a low pressure. The third check valve 213 that is arranged in the middle of the third air flow path 113 regulates the inflow of a gas from the third air flow path 113 to the decompression chamber 760. However, due to the inflow of a gas from the bubble retention chamber 520 through the gas permeable membrane 710 and the inflow of a gas that slightly permeates a member forming the decompression chamber 760, the pressure in the decompression chamber 760 is gradually increased with the passage of time. In such case in which the pressure in the decompression chamber 760 is gradually increased with the passage of time, the bubble extraction decompression operation of decreasing the pressure in the decompression chamber 760 is required. When it is estimated that the pressure in the decompression chamber 760 exceeds a predetermined pressure based on the elapsed time after the previous bubble extraction decompression operation, the ink supply unit 400 performs the bubble extraction decompression operation. At the time of the bubble extraction decompression operation, the ink supply unit 400 drives the one-way pump 404 to decrease the pressure in the decompression chamber 760 under a state in which the first on-off valve 408 is closed, the second on-off valve 405 is closed, the third on-off valve 407 is closed and the fourth on-off valve 406 is opened. When a predetermined period of time has elapsed after the one-way pump 404 is driven, and it is estimated that the pressure in the decompression chamber 760 reaches a predetermined pressure or less, the ink supply unit 400 stops the drive of the one-way pump 404. During this time, the first on-off valve 408 and the second on-off valve 405 are closed, and hence the pressure of the gas in the intermediate pressure chamber 403 is maintained at a positive pressure. The third check valve 213 is closed even when the pressure in each of the intermediate pressure chamber 403 and the first to third air flow paths is fluctuated due to the above-mentioned pressure chamber pressurization operation, pressurization maintenance operation, ink replenishment operation and the like after the bubble extraction decompression operation, and hence the pressure in the decompression chamber 760 is maintained at a low pressure (negative pressure). For example, under situations in which a bubble is liable to be generated, such as a situation at the start of initial use and a situation after cleaning, the frequency at which the bubble extraction decompression operation is performed may be increased. The frequency at which the bubble extraction decompression operation is performed may be decreased at the time of the start of initial use or with the passage of time after cleaning. In addition, the frequency at which the bubble extraction decompression operation is performed may be changed depending on the temperature, the usage state and the like.

### [Recording Head]

FIG. 5 is an exploded perspective view for illustrating an example of a recording head. The basic configuration of the recording head is described below mainly with reference to FIG. 5 and with reference to FIG. 2 as required. Here, an example including a circulation unit is described, but the circulation unit may be omitted. As illustrated in FIG. 5, the recording head 1 is configured so as to include the circulation unit 54 and the ejection unit 3 that ejects an ink supplied from the circulation unit 54, to the recording medium P. The recording head 1 is fixedly supported on the carriage 60 with a positioning unit and an electrical contact (which are not shown) arranged on the carriage 60 of the recording unit 50. The recording head 1 performs recording on the recording medium P by ejecting an ink while moving in the main scanning direction (X direction) indicated in FIG. 2 together with the carriage 60.

A second support member 7 having openings 7a for inserting ejection modules 300 is bonded and fixed to one surface of a first support member 4. The second support member 7 holds an electrical wiring member 5 that is electrically connected to the ejection modules 300. The electrical wiring member 5 applies an electric signal for ejecting an ink, to the ejection modules 300. The electrical connection portion between the ejection modules 300 and the electrical wiring member 5 is sealed with a sealing material (not shown) to be protected from ink corrosion and an external impact. In addition, an electrical contact substrate 6 is subjected to thermal compression bonding to an end portion 5a of the electrical wiring member 5 through use of, for example, an anisotropic conductive film (not shown), and thus the electrical wiring member 5 and the electrical contact substrate 6 are electrically connected to each other. The electrical contact substrate 6 includes an external signal input terminal (not shown) for receiving an electric signal from the recording unit 50.

As illustrated in FIG. 2, the ink supply unit 400 connected to the ink storage portion 2 serving as a supply source of an ink includes the first supply path 111 and the second supply path 112. A main body side connecting member is arranged at a distal end of the second supply path 112. When the recording head 1 is mounted on the recording unit 50, the main body side connecting member arranged at the distal end of the second supply path 112 is detachably connected to a head side connecting member 800 arranged in a head housing 53 of the recording head 1. As a result, ink supply paths (first supply path 111 and second supply path 112) leading to the recording head 1 from the ink storage portion 2 through the ink supply unit 400 are formed. The recording head 1 uses four kinds of inks. Thus, the ink storage portion 2, the first supply path 111, the second supply path 112 and the circulation unit 54 are each arranged in four sets corresponding to the respective inks, and four ink supply paths corresponding to the respective inks are independently formed. In this manner, the recording unit 50 includes an ink supply system in which an ink is supplied from the ink storage portion 2 arranged outside the recording head 1.

### [Configuration of Bubble Extraction Unit]

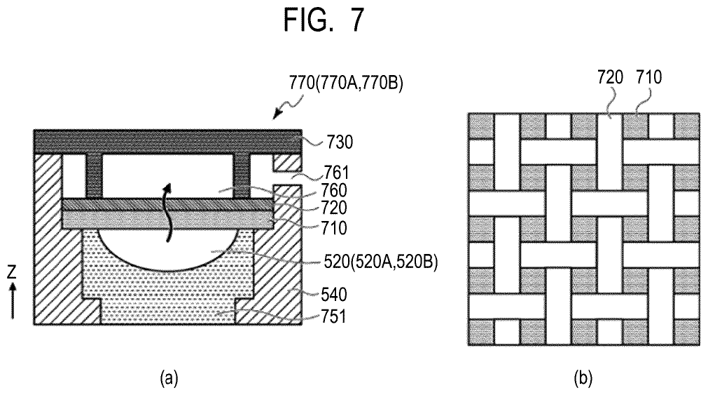

FIG. 7 is a schematic view for illustrating an example of a bubble extraction unit. Part (a) of FIG. 7 is a sectional view of a bubble extraction unit 770. Part (b) of FIG. 7 is a schematic view of a deformation suppressing member 720 in the bubble extraction unit 770. A second bubble extraction unit 770B has the same configuration as that of a first bubble extraction unit 770A. A second bubble retention chamber 520B has the same configuration as that of a first bubble retention chamber 520A. The first bubble extraction unit 770A and the second bubble extraction unit 770B may hereinafter be collectively described as “bubble extraction unit 770”. In addition, the first bubble retention chamber 520A and the second bubble retention chamber 520B may be collectively described as “bubble retention chamber 520”. As illustrated in part (a) of FIG. 7, the bubble extraction unit 770 (first bubble extraction unit 770A and second bubble extract unit 770B) includes the bubble retention chamber 520 (first bubble retention chamber 520A and second bubble retention chamber 520B) and the decompression chamber 760. Further, the bubble extraction unit 770 includes the gas permeable membrane 710, the deformation suppressing member 720, a first communication port 751 for causing the bubble retention chamber 520 and the ink flow paths or the liquid chambers to be in communication with each other and a second communication port 761 for causing the decompression chamber 760 and the ink supply unit 400 to be in communication with each other.

The bubble extraction unit 770 (first bubble extraction unit 770A and second bubble extraction unit 770B) is in communication with the ink supply unit 400 arranged in a main body portion of the recording unit 50 and is decompressed by the operation of the ink supply unit 400. Further, the third check valve 213 (FIG. 3 and FIG. 4) is arranged between the bubble extraction unit 770 and the ink supply unit 400, and hence the bubble extraction operation can be performed when the decompressed state is maintained even without the operation of the recording unit 50. The third check valve 213 may be arranged in each of branched portions of the third air flow path 113 between the ink supply unit 400 and the first bubble extraction unit 770A and between the ink supply unit 400 and the second bubble extraction unit 770B. The third check valve 213 may also be arranged in each of converged portions of the third air flow path 113 between the ink supply unit 400 and the first bubble extraction unit 770A and between the ink supply unit 400 and the second bubble extraction unit 770B.

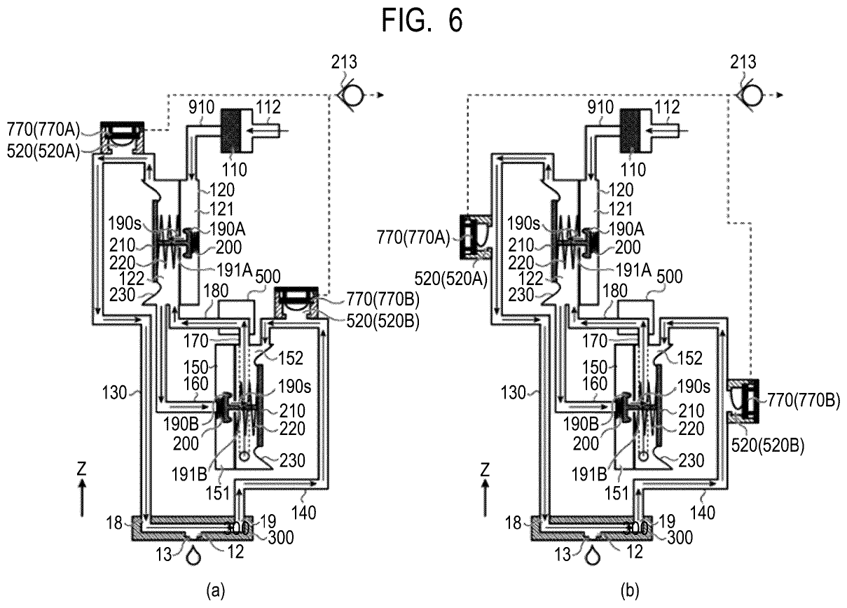

FIG. 6 is a vertical sectional view for illustrating an example of a circulation path. As illustrated in part (a) of FIG. 6, the first bubble extraction unit 770A is arranged on an upper side in a vertical direction of a supply flow path 130, and the second bubble extraction unit 770B is arranged on an upper side in a vertical direction of a first collecting flow path 140, but the configuration is not limited thereto. One bubble extraction unit 770 (first bubble extraction unit 770A) may be arranged only in the supply flow path 130. The bubble extraction unit 770 may be arranged on an upper side in a vertical direction of the ink storage portion 2, the first supply path 111, the second supply path 112, a third supply path 910, the filter 110, a pump inlet flow path 170, a pump outlet flow path 180, a bypass flow path 160, the pressure chamber 12 or the like. In addition, as illustrated in part (b) of FIG. 6, the first bubble retention chamber 520A may be formed so as to be in communication with a side surface of the supply flow path 130, and the first bubble extraction unit 770A may be formed so as to extend to the side of the first bubble retention chamber 520A. The second bubble retention chamber 520B may be formed so as to be in communication with a side surface of the first collecting flow path 140, and the second bubble extraction unit 770B may be formed so as to extend to the side of the second bubble retention chamber 520B. As long as the configuration is such that the bubble can be trapped and brought into contact with the gas permeable membrane 710, the bubble retention chamber 520 may be formed so as to be in communication with the side surface of the communication portion other than the supply flow path 130 and the first collecting flow path 140, and the bubble extraction unit 770 may be formed so as to extend to the side of the bubble retention chamber 520. In other words, the bubble extraction unit 770 may be formed so as to extend in the horizontal direction from the bubble retention chamber 520 instead of the upper side in the vertical direction of the bubble retention chamber 520. From the viewpoint of the bubble extraction efficiency, it is preferable that the decompression chamber be arranged adjacent to the upper side in the vertical direction of the liquid retention chamber.

The pressure chamber 12, a common supply flow path 18 and a common collecting flow path 19 are formed with respect to each of a plurality of ejection orifices 13 forming an ejection orifice array. A first pressure adjustment unit 120 includes a first valve chamber 121 and a first pressure control chamber 122. A second pressure adjustment unit 150 includes the second valve chamber 151 and the second pressure control chamber 152. The first pressure adjustment unit 120 is configured so that the control pressure is relatively higher than the control pressure of the second pressure adjustment unit 150. The first valve chamber 121 is in communication with the first pressure control chamber 122 through a communication port 191A that can be opened and closed by a valve 190A illustrated in FIG. 6. A valve shaft 190s to be inserted into the communication port 191A protrudes in a center portion of the valve 190. When the valve shaft 190s is pressed against the urging force of a valve spring 200, the valve 190 is separated from a partition wall (not shown) to enable the flow of an ink in the communication port 191. The second valve chamber 151 is in communication with the second pressure control chamber 152 through a communication port 191B that is opened and closed by a valve 190B illustrated FIG. 6. A pressure adjustment spring 220 serving as an urging member is arranged between a pressure plate 210 and the partition wall (not shown). Due to the urging force of the pressure adjustment spring 220, the pressure plate 210 and a flexible member 230 are urged in a direction in which the internal volume of the first pressure control chamber 122 is increased. In addition, when the pressure in the first pressure control chamber 122 is decreased, the pressure plate 210 and the flexible member 230 are displaced in a direction in which the internal volume of the first pressure control chamber 122 is reduced against the pressure of the pressure adjustment spring 220.

### [Gas Permeable Membrane]

As illustrated in part (a) of FIG. 7, the gas permeable membrane 710 is formed in a housing portion of the circulation unit 54 forming the bubble retention chamber 520 so as to separate the bubble retention chamber 520 and the decompression chamber 760 from each other. The housing portion of the circulation unit 54 forming the bubble retention chamber 520 is hereinafter referred to as “unit housing 540”. The gas permeable membrane 710 is bonded to the unit housing 540, for example, by bonding methods such as thermal welding, ultrasonic welding and laser welding. Any one of the bonding methods such as thermal welding, ultrasonic welding and laser welding may be used as long as the bubble retention chamber 520 is sealed so as to prevent the ink from leaking into the decompression chamber 760.

The gas permeable membrane 710 is a member having flexibility and preferably has a planar shape. As the gas permeable membrane 710, a membrane formed of a material having a free volume or pores sufficient for allowing the permeation of, for example, air that is a mixed gas of oxygen gas, nitrogen gas and the like, specifically, an oxygen molecule, a nitrogen molecule and a mixture of those molecules (hereinafter collectively referred to as “gas”) is used. When a gas permeable membrane formed of a material having pores is used, the pore size (diameter) is only required to allow the permeation of the above-mentioned gas without allowing the permeation of an ink. For example, the diameter is preferably 100 nm or less, and is preferably 0.01 nm or more. The material of the gas permeable membrane 710 is preferably a resin. Specifically, examples of the material of the gas permeable membrane 710 include polypropylene (PP), polyethylene (PE), polymethylpentene (TPX) and polytetrafluoroethylene (PTFE). In order to enhance the bubble extraction efficiency, the material of the gas permeable membrane 710 preferably has high gas permeability. In addition, the material of the gas permeable membrane 710 is required to be easily bonded to the unit housing 540 by thermal welding and not to cause tearing or peeling. Further, the material of the gas permeable membrane 710 is required to have reliability as a liquid-contact material. Thus, the material of the gas permeable membrane 710 is preferably selected from the viewpoints of gas permeability, a production method (productivity) and reliability. The material of the gas permeable membrane is preferably polypropylene or polyethylene, more preferably polypropylene because those materials are excellent in gas permeability and can further improve ejection stability.

The surface energy γm (mN/m) of the gas permeable membrane 710 is preferably 24 mN/m or more, more preferably 29 mN/m or more, and is preferably 40 mN/m or less. When the surface energy γₘ of the gas permeable membrane is less than 24 mN/m, the wettability of the ink to the gas permeable membrane is slightly decreased, and hence the bubble extraction property may be decreased to reduce the effect of improving the ejection stability of the ink. The surface energy γₘ of the gas permeable membrane may be measured with Dyne Pen (e.g., product name “Dyne Pen”, manufactured by Arcotest GmbH) in conformity with ISO 8296, DIN 53364, ASTM 2587, JIS K 6768 and the like. Dyne Pen to be used for measuring the surface energy of a gas permeable membrane is not limited thereto. In addition, if the measurement method is not limited to a method using Dyne Pen as long as the surface energy of the gas permeable membrane can be measured.

The SP value of a resin to be used as a material of the gas permeable membrane 710 is preferably 5.0 (cal/cm³)^{1/2} or more to 15.0 (cal/cm³)^{1/2} or less. In particular, the SP value is more preferably 5.0 (cal/cm³)^{1/2} or more to 10.0 (cal/cm³)^{1/2} or less. When the SP value of the resin for forming the gas permeable membrane is outside the above-mentioned range, the wettability of the ink to the gas permeable membrane is slightly decreased, and hence the bubble extraction property may be decreased to reduce the effect of improving the ejection stability of the ink.

Examples of a bubble that flows into the bubble retention chamber 520 include an initial bubble that remains at the start of initial use, that is, after initial filling (about 0.2 mL), a storage portion replacement bubble that flows into the bubble retention chamber 520 during normal use (about 0.015 mL per month) and a permeation bubble that permeates the bubble retention chamber 520 from outside (about 0.001 mL/day). In order to treat those bubbles, it is preferable that the bubble extraction operation be performed in a permeation amount of a bubble of 0.01 mL/day or more. As specified in “JIS K7126-1”, the permeation amount of a gas through the gas permeable membrane 710 can be verified by a pressure sensor method. The pressure sensor method is a method involving measuring a gas permeation degree by keeping one side (low-pressure side) separated by a test piece in a vacuum, introducing a test gas into another side (high-pressure side) and measuring an increase in pressure on the low-pressure side. According to the pressure sensor method, a gas permeation coefficient can be calculated from the gas permeation degree and the thickness of the test piece. In the pressure sensor method, the permeation amount of a gas through the gas permeable membrane can be verified by measuring the gas permeation degree with the test piece being as the gas permeable membrane. An ink is filled into the recording head 1 by suction, the bubble in the bubble retention chamber 520 is brought into contact with the entire gas permeable membrane 710, and the recording head 1 is left in an environment with, for example, a normal temperature (25° C.) and a normal pressure (1 atm) under a state in which the pressure of the gas in the decompression chamber 760 is maintained at a negative pressure of about 50 kPa by the ink supply unit 400. The amount of the bubble in the bubble retention chamber 520 is measured in chronological order by computed tomography (CT) or the like in a series of such operations, and thus the permeation amount of the bubble (gas) through the gas permeable membrane 710 can be verified.

In order to weld the gas permeable membrane 710 to the unit housing 540 to seal the bubble retention chamber 520, the material of the gas permeable membrane 710 preferably has high reliability of welding of the gas permeable membrane 710 and high reliability as a liquid-contact material. In addition, the gas permeable membrane 710 removes a bubble by decompression and hence is required to have strength that can withstand the decompression. Thus, the thickness of the gas permeable membrane 710 is required to be 0.01 mm or more. Meanwhile, in order to achieve a bubble permeation amount of 0.01 mL/day or more, the thickness of the gas permeable membrane 710 is preferably 0.10 mm or less, more preferably less than 0.10 mm, particularly preferably 0.09 mm or less. When the thickness is 0.10 mm or less, the bubble is easily extracted, and hence the ejection stability can be further improved.

### [Bubble Retention Chamber]

FIG. 6 is a vertical sectional view for illustrating an example of a circulation path. As illustrated in part (a) of FIG. 6, the first bubble retention chamber 520A is arranged on the upper side in the vertical direction of the supply flow path 130 so as to be in communication with the supply flow path 130 through the first communication port 751. The second bubble retention chamber 520B is arranged on the upper side in the vertical direction of the first collecting flow path 140 so as to be in communication with the first collecting flow path 140 through the first communication port 751. As a result, the bubble mixed into the ink in the first pressure adjustment unit 120, the second pressure adjustment unit 150, the supply flow path 130, the first collecting flow path 140 and the like due to circulation and an ejection operation can be trapped in the bubble retention chamber 520 to be discharged from the ink by the bubble extraction operation. Examples of the bubble mixed into the ink include an upstream bubble that has entered the recording head due to replacement of the ink storage portion 2, an eluted bubble that is generated in the recording head due to environmental changes and an unexpected bubble that is generated in the recording head unexpectedly. The kind of the bubble discharged by the bubble extraction operation is not limited thereto. As long as the bubble can be trapped in the bubble retention chamber 520, and the amount of the bubble is large enough to achieve a sufficient bubble extraction speed, the bubble mixed into the ink can be discharged to the outside of the recording head 1.

Examples of the material of the unit housing 540 forming the bubble retention chamber 520 include polypropylene (PP) and polyethylene (PE). The material of the unit housing 540 is preferably polypropylene because the ejection stability can be further improved in addition to the viewpoints of reliability of welding of the gas permeable membrane 710 and ease of handling.

### [Decompression Chamber]

As illustrated in part (a) of FIG. 7, the decompression chamber 760 includes: an opening portion in which the gas permeable membrane 710 is arranged; an opening portion for welding the gas permeable membrane 710 opposed to the above-mentioned opening portion; and the second communication port 761. The decompression chamber 760 is formed so as to be surrounded by the unit housing 540, the gas permeable membrane 710 and a cover member 730. The second communication port 761 is formed so as to penetrate through a side portion of the unit housing 540 and causes the decompression chamber 760 and a deaeration flow path to be in communication with each other. The opening portion for welding of the gas permeable membrane 710 is sealed by bonding the cover member 730 that is a separate member to the unit housing 540. Examples of a bonding method of the cover member 730 include thermal welding, ultrasonic welding and laser welding. Examples of the material of the cover member 730 include polypropylene (PP) and polyethylene (PE). From the viewpoints of reliability of welding of the cover member 730 and ease of handling, it is preferable that the material of the cover member 730 be the same as that of the unit housing 540 forming the bubble retention chamber 520.

### [Principle of Bubble Extraction]

At the time of the bubble extraction operation, when the decompression chamber 760 is put into a decompressed state, the pressure difference between the pressure of the bubble in the bubble retention chamber 520 and the pressure of the gas in the decompression chamber 760 causes the bubble to permeate the gas permeable membrane 710. The permeation amount in the bubble extraction operation is represented by the following formula (X). In the formula (X), Q represents a gas permeation amount, P represents a permeation coefficient, “p” represents a decompression degree (gauge pressure), S represents a bubble contact area, “t” represents time, and L represents the thickness of the gas permeable membrane 710.

$$Q = P \times p \times S \times t / L \qquad ( X )$$

The gas permeation amount represented by the Q is the permeation amount of the gas contained in the bubble by the bubble extraction operation. The permeation coefficient represented by the P is a numerical value determined by the material physical properties of the gas permeable membrane 710 and represents the basic speed of the bubble extraction operation. The decompression degree represented by the “p” is the decompression degree (gauge pressure) of the decompression chamber 760. The bubble contact area represented by the S is the area of the bubble in contact with the gas permeable membrane 710. The numerical value represented by the L is the thickness of the gas permeable membrane 710. When the decompression degree is higher, the permeation amount of the bubble is increased. In order to ensure the permeation amount of the bubble sufficient for treating the bubble generated during normal use and to further improve the ejection stability, the decompression degree is preferably set to 10 kPa or more. The decompression degree is preferably 70 kPa or less.

The operation of the bubble extraction unit has been described by way of an example of a configuration in which the bubble extraction unit 770 (first bubble extraction unit 770A and second bubble extraction unit 770B) includes the bubble retention chamber 520 (first bubble retention chamber 520A and second bubble retention chamber 520B), but the present disclosure is not limited thereto. A liquid retention chamber capable of retaining an ink may be arranged between the pressure chamber 12 and the decompression chamber 760 so that the bubble is retained in a part of the liquid retention chamber. In this case, the gas permeable membrane is arranged at a position connected to the liquid retention chamber, and the decompression chamber is adjacent to the liquid retention chamber through the gas permeable membrane.

The configuration of the circulation path is not limited to the above-mentioned configuration. A first configuration example and a second configuration example of the ink path and each modification example of the circulation path are described below as other configurations of the circulation path.

### [First Configuration Example of Ink Path]

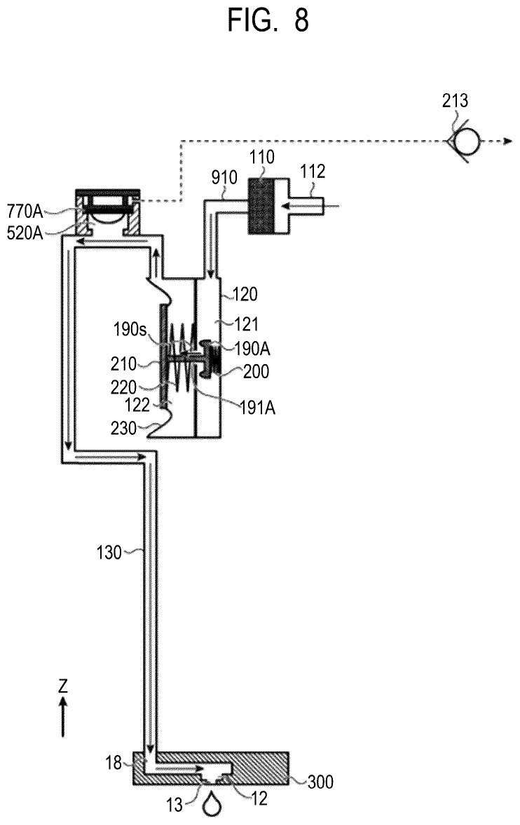

FIG. 8 is a view for schematically illustrating a first configuration example of an ink path. The first configuration example of the ink path is an example in which the second pressure adjustment unit 150 and the second bubble retention chamber 520B, the circulation pump 500, the bypass flow path 160 and the first collecting flow path 140 in FIG. 6 are not arranged. In the first configuration example of the ink path, ink circulation is not performed, and the ink supplied from the second supply path 112 flows through the first pressure adjustment unit 120, the supply flow path 130 and the pressure chamber 12 in the stated order to be ejected from the ejection orifice 13. The first pressure control chamber 122, the supply flow path 130 and the pressure chamber 12 are subjected to pressure control by the first pressure adjustment unit 120, to thereby achieve the stable ejection of an ink.

The first bubble retention chamber 520A is arranged on the upper side in the vertical direction of the supply flow path 130 so as to be in communication with the supply flow path 130, and the first bubble extraction unit 770A is formed so as to extend to an upper side in a vertical direction of the first bubble retention chamber 520A. As a result, the bubble mixed into the ink in the first pressure adjustment unit 120, the supply flow path 130 or the like due to the circulation and ejection operation can be trapped in the first bubble retention chamber 520A to be discharged from the ink by the bubble extraction operation. Examples of the bubble to be mixed into the ink include the above-mentioned upstream bubble, eluted bubble and unexpected bubble, but are not limited thereto. The bubble in an amount to the extent that the bubble can be trapped in the bubble retention chamber 520 and the bubble extraction speed is sufficiently obtained can be discharged from the ink. Thus, the possibility of the bubble entering the ink flow path that is in communication with the ejection orifice 13 can be significantly decreased.

The first bubble extraction unit 770A is in communication with the ink supply unit 400 in the main body portion of the recording unit 50 and is decompressed by the operation of the ink supply unit 400. Further, the third check valve 213 is arranged between the bubble extraction unit 770 and the ink supply unit 400, and the decompressed state is maintained even when the main body portion of the recording unit 50 is not always in operation, with the result that the bubble extraction operation can be performed. The third check valve 213 may be arranged in the third air flow path 113 between the first bubble extraction unit 770A and the ink supply unit 400.

The bubble retention chamber 520 and the bubble extraction unit 770 may be arranged at two or more positions. In addition, the bubble retention chamber 520 and the bubble extraction unit 770 are not required to be arranged in the supply flow path 130. For example, the bubble retention chamber 520 and the bubble extraction unit 770 may be arranged on the upper side in the vertical direction of the ink storage portion 2, the first supply path 111, the second supply path 112, the third supply path 910, the filter 110, the pressure chamber 12 and the like. In addition, the bubble retention chamber 520 and the bubble extraction unit 770 are not always required to be arranged on the upper side in the vertical direction of communication portions of the supply flow path 130 and the like. As long as the configuration is such that the bubble can be trapped and brought into contact with the gas permeable membrane, the bubble retention chamber 520 may be formed so as to be in communication with the side surface of the communication portion, and the bubble extraction unit 770 may be formed so as to extend to the side of the bubble retention chamber 520. The same holds true for the case in which the bubble retention chambers 520 and the bubble extraction units 770 are arranged in a plurality of portions of the communication portions other than the supply flow path 130 and the first collecting flow path 140.

### [First Modification Example of Circulation Path]

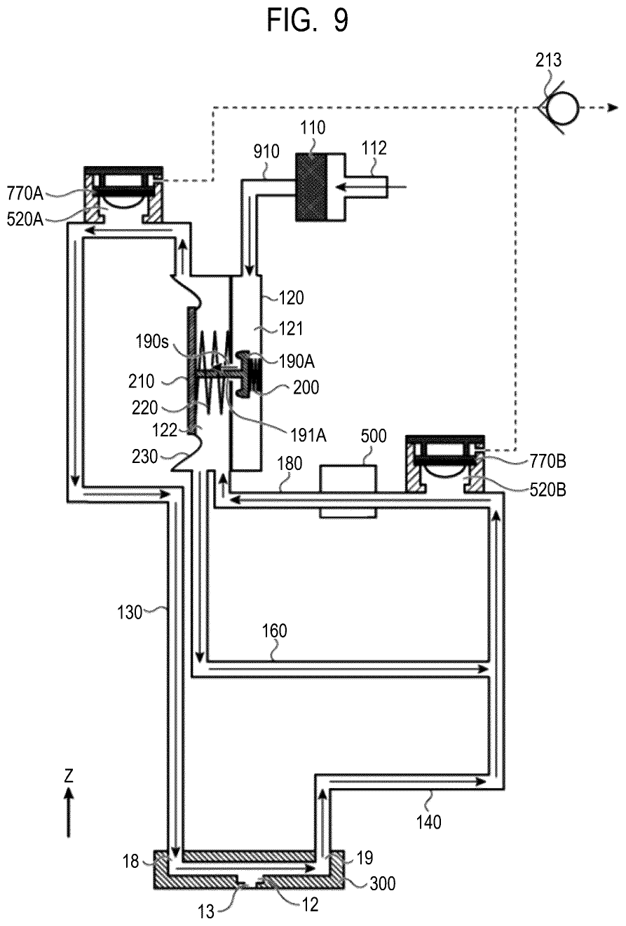

FIG. 9 is a view for schematically illustrating a first modification example of a circulation path. FIG. 9 shows a circulation path in the case in which ejection is not performed and circulation is performed. The first modification example of the circulation path is an example in which the second pressure adjustment unit 150 in FIG. 6 is not arranged, and a bypass flow path 160 and the first collecting flow path 140 are directly connected to each other.

In the first modification example of the circulation path, the flow path resistance of the flow path of an ink flowing to the first collecting flow path 140 through the bypass flow path 160 is represented by R1, and the flow path resistance of the flow path of an ink flowing from the supply flow path 130 to the first collecting flow path 140 through the ejection module 300 is represented by R2. The flow rate of an ink flowing through each flow path is inversely proportional to the flow path resistance, and hence the ratio between the flow rate of an ink in the flow path through the bypass flow path 160 and the flow rate of an ink in the flow path through the ejection module 300 is R2:R1. Each flow path resistance is set so as to achieve the circulation amount capable of suppressing the thickening of an ink in the vicinity of the ejection orifice 13 in the ejection module 300 in accordance with the above-mentioned relationship. That is, each flow path resistance is set so that the flow speed of the ink in the pressure chamber 12 reaches a predetermined flow speed or more. The flow path resistance R1 of the flow path through the bypass flow path 160 is controlled by, for example, changing the sectional area of the flow path or the length of the flow path and arranging a throttle in the flow path.

The first bubble retention chamber 520A is arranged on the upper side in the vertical direction of the supply flow path 130 so as to be in communication with the supply flow path 130, and the first bubble extraction unit 770A is formed so as to extend to the upper side in the vertical direction of the first bubble retention chamber 520A. In addition, the second bubble retention chamber 520B is arranged on the upper side in the vertical direction of the first collecting flow path 140 so as to be in communication with the first collecting flow path 140, and the second bubble extraction unit 770B is formed so as to extend to an upper side in a vertical direction of the second bubble retention chamber 520B. As a result, the bubble mixed into the ink in the first pressure adjustment unit 120, the supply flow path 130, the first collecting flow path 140 and the like due to the circulation and ejection operation can be trapped in the bubble retention chamber 520 to be discharged from the ink by the bubble extraction operation. Examples of the bubble to be mixed into the ink include the above-mentioned upstream bubble, eluted bubble and unexpected bubble, but are not limited thereto. The bubble in an amount to the extent that the bubble can be trapped in the bubble retention chamber 520 and the bubble extraction speed is sufficiently obtained can be discharged from the ink. Thus, the possibility of the bubble entering the ink flow path that is in communication with the ejection orifice 13 can be significantly decreased.

The first bubble extraction unit 770A and the second bubble extraction unit 770B are in communication with the ink supply unit 400 in the main body portion of the recording unit 50 and are decompressed by the operation of the ink supply unit 400. Further, the third check valve 213 is arranged between the bubble extraction unit 770 and the ink supply unit 400, and the decompressed state is maintained even when the main body portion of the recording unit 50 is not always in operation, with the result that the bubble extraction operation can be performed. The third check valve 213 may be arranged in each of branched portions of the third air flow path 113 between the ink supply unit 400 and the first bubble extraction unit 770A and between the ink supply unit 400 and the second bubble extraction unit 770B. The third check valve 213 may also be arranged in each of converged portions of the third air flow path 113 between the ink supply unit 400 and the first bubble extraction unit 770A and between the ink supply unit 400 and the second bubble extraction unit 770B.

The bubble retention chamber 520 and the bubble extraction unit 770 are not required to be arranged in both the supply flow path 130 and the first collecting flow path 140, but may be arranged only in the supply flow path 130 or only in the first collecting flow path 140. In addition, the bubble retention chamber 520 and the bubble extraction unit 770 may be arranged at three or more positions. The bubble retention chamber 520 and the bubble extraction unit 770 are also not required to be arranged in the supply flow path 130 and the first collecting flow path 140. For example, the bubble retention chamber 520 and the bubble extraction unit 770 may be arranged on the upper side in the vertical direction of the ink storage portion 2, the first supply path 111, the second supply path 112 and the third supply path 910. The bubble retention chamber 520 and the bubble extraction unit 770 may be arranged on an upper side in a vertical direction of the filter 110, the pump outlet flow path 180, the bypass flow path 160, the pressure chamber 12 and the like. In addition, the bubble retention chamber 520 and the bubble extraction unit 770 are not always required to be arranged on the upper side in the vertical direction of the communication portions of the supply flow path 130 and the like. As long as the configuration is such that the bubble can be trapped and brought into contact with the gas permeable membrane, the bubble retention chamber 520 may be formed so as to be in communication with the side surface of the communication portion, and the bubble extraction unit 770 may be formed so as to extend to the side of the bubble retention chamber 520. The same holds true for the case in which the bubble retention chambers 520 and the bubble extraction units 770 are arranged in a plurality of portions of the communication portions other than the supply flow path 130 and the first collecting flow path 140.

### [Second Configuration Example of Ink Path]

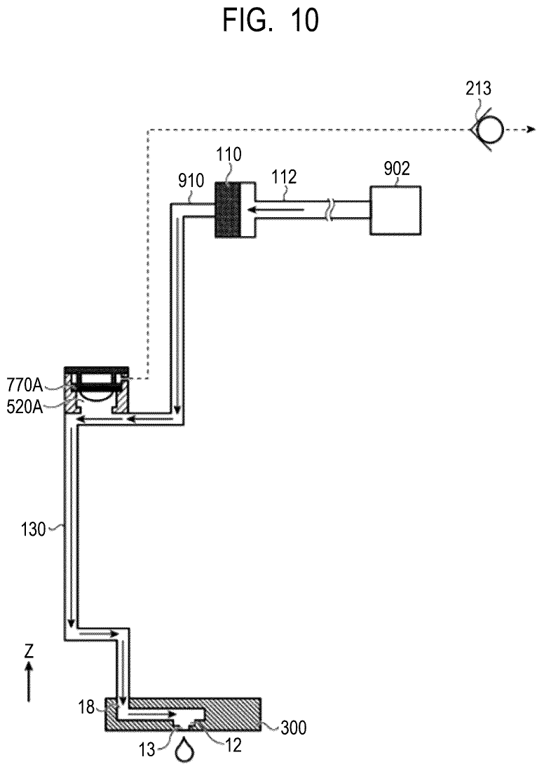

FIG. 10 is a view for schematically illustrating a second configuration example of an ink path. The second configuration example of the ink path is an example in which the first pressure adjustment unit 120 and the second pressure adjustment unit 150, the second bubble retention chamber 520B, the circulation pump 500, the bypass flow path 160 and the first collecting flow path 140 in FIG. 6 are not arranged. The second configuration example of the ink path is an example in which a third pressure adjustment unit 902 that is in communication with the second supply path 112 is arranged instead of the first pressure adjustment unit 120, the second pressure adjustment unit 150 and the like. In the second configuration example of the ink path, ink circulation is not performed, and the ink supplied from the second supply path 112 flows through the supply flow path 130 and the pressure chamber 12 in the stated order to be ejected from the ejection orifice 13. The second supply path 112, the third supply path 910, the supply flow path 130 and the pressure chamber 12 are subjected to pressure control by the third pressure adjustment unit 902, to thereby achieve the stable ejection of an ink.

The third pressure adjustment unit 902 is arranged outside the recording head 1 and is in communication with the third supply path 910 of the recording head 1 through the second supply path 112. An example of the third pressure adjustment unit 902 is a hydraulic head system utilizing a hydraulic head difference, but any system may be applied. This modification example may be applied to an ink cartridge system in which an ink cartridge is replaced when the ink stored in the ink storage portion has been consumed, an ink supply system such as a so-called CISS system (continuous ink supply system) in which an ink is injected through an inlet port or the like.

The first bubble retention chamber 520A is arranged on the upper side in the vertical direction of the supply flow path 130 so as to be in communication with the supply flow path 130, and the first bubble extraction unit 770A is formed so as to extend to an upper side in a vertical direction of the first bubble retention chamber 520A. As a result, the bubble mixed into the ink in the supply flow path 130 or the like due to the circulation and ejection operation can be trapped in the first bubble retention chamber 520A to be discharged from the ink by the bubble extraction operation. Examples of the bubble to be mixed into the ink include the above-mentioned upstream bubble, eluted bubble and unexpected bubble, but are not limited thereto. The bubble in an amount to the extent that the bubble can be trapped in the bubble retention chamber 520 and the bubble extraction speed is sufficiently obtained can be discharged from the ink. Thus, the possibility of the bubble entering the ink flow path that is in communication with the ejection orifice 13 can be significantly decreased.

The first bubble extraction unit 770A is in communication with the ink supply unit 400 in the main body portion of the recording unit 50 and is decompressed by the operation of the ink supply unit 400. Further, the third check valve 213 is arranged between the bubble extraction unit 770 and the ink supply unit 400, and the decompressed state is maintained even when the main body portion of the recording unit 50 is not always in operation, with the result that the bubble extraction operation can be performed. The third check valve 213 may be arranged in the third air flow path 113 between the first bubble extraction unit 770A and the ink supply unit 400.

The bubble retention chamber 520 and the bubble extraction unit 770 may be arranged at two or more positions. In addition, the bubble retention chamber 520 and the bubble extraction unit 770 are not required to be arranged in the supply flow path 130. For example, the bubble retention chamber 520 and the bubble extraction unit 770 may be arranged on the upper side in the vertical direction of the ink storage portion 2, the first supply path 111, the second supply path 112, the third supply path 910, the filter 110, the pressure chamber 12 and the like. In addition, the bubble retention chamber 520 and the bubble extraction unit 770 are not always required to be arranged on the upper side in the vertical direction of communication portions of the supply flow path 130 and the like. As long as the configuration is such that the bubble can be trapped and brought into contact with the gas permeable membrane, the bubble retention chamber 520 may be formed so as to be in communication with the side surface of the communication portion, and the bubble extraction unit 770 may be formed so as to extend to the side of the bubble retention chamber 520. The same holds true for the case in which the bubble retention chambers 520 and the bubble extraction units 770 are arranged in a plurality of portions of the communication portions other than the supply flow path 130 and the first collecting flow path 140.

### [Second Modification Example of Circulation Path]

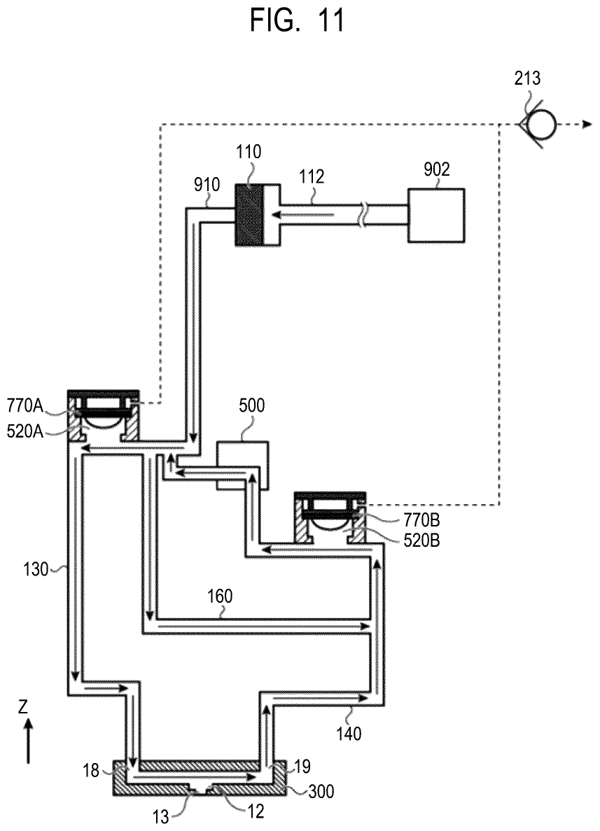

FIG. 11 is a view for schematically illustrating a second modification example of a circulation path. FIG. 11 shows a circulation path in the case in which ejection is not performed and circulation is performed. The second modification example of the circulation path is an example in which the first pressure adjustment unit 120 and the second pressure adjustment unit 150 in FIG. 6 are not arranged, and a bypass flow path 160 and the first collecting flow path 140 are directly connected to each other.

In the second modification example of the circulation path, the flow path resistance of the flow path of an ink flowing to the first collecting flow path 140 through the bypass flow path 160 is represented by R1, and the flow path resistance of the flow path of an ink flowing from the supply flow path 130 to the first collecting flow path 140 through the ejection module 300 is represented by R2. The flow rate of an ink flowing through each flow path is inversely proportional to the flow path resistance, and hence the ratio between the flow rate of an ink in the flow path through the bypass flow path 160 and the flow rate of an ink in the flow path through the ejection module 300 is R2:R1. Each flow path resistance is set so as to achieve the circulation amount capable of suppressing the thickening of an ink in the vicinity of the ejection orifice 13 in the ejection module 300 in accordance with the above-mentioned relationship. That is, each flow path resistance is set so that the flow speed of the ink in the pressure chamber 12 reaches a predetermined flow speed or more. The flow path resistance R1 of the flow path through the bypass flow path 160 is controlled by, for example, changing the sectional area of the flow path or the length of the flow path and arranging a throttle in the flow path.

The third pressure adjustment unit 902 is arranged outside the recording head 1 and is in communication with the third supply path 910 of the recording head 1 through the second supply path 112. An example of the third pressure adjustment unit 902 is a hydraulic head system utilizing a hydraulic head difference, but any system may be applied. This modification example may also be applied to any of the above-mentioned systems, that is, the ink cartridge system or the ink supply system, such as the CISS system.

The first bubble retention chamber 520A is arranged on the upper side in the vertical direction of the supply flow path 130 so as to be in communication with the supply flow path 130, and the first bubble extraction unit 770A is formed so as to extend to the upper side in the vertical direction of the first bubble retention chamber 520A. In addition, the second bubble retention chamber 520B is arranged on the upper side in the vertical direction of the first collecting flow path 140 so as to be in communication with the first collecting flow path 140, and the second bubble extraction unit 770B is formed so as to extend to an upper side in a vertical direction of the second bubble retention chamber 520B. As a result, the bubble mixed into the ink in the supply flow path 130, the first collecting flow path 140, the pump inlet flow path 170, the pump outlet flow path 180 and the like due to the circulation and ejection operation can be trapped in the bubble retention chamber 520 to be discharged from the ink by the bubble extraction operation. Examples of the bubble to be mixed into the ink include the above-mentioned upstream bubble, eluted bubble and unexpected bubble, but are not limited thereto. The bubble in an amount to the extent that the bubble can be trapped in the bubble retention chamber 520 and the bubble extraction speed is sufficiently obtained can be discharged from the ink. Thus, the possibility of the bubble entering the ink flow path that is in communication with the ejection orifice 13 can be significantly decreased.

The first bubble extraction unit 770A and the second bubble extraction unit 770B are in communication with the ink supply unit 400 in the main body portion of the recording unit 50 and are decompressed by the operation of the ink supply unit 400. Further, the third check valve 213 is arranged between the bubble extraction unit 770 and the ink supply unit 400, and the decompressed state is maintained even when the main body portion of the recording unit 50 is not always in operation, with the result that the bubble extraction operation can be performed. The third check valve 213 may be arranged in each of branched portions of the third air flow path 113 between the ink supply unit 400 and the first bubble extraction unit 770A and between the ink supply unit 400 and the second bubble extraction unit 770B. The third check valve 213 may also be arranged in each of converged portions of the third air flow path 113 between the ink supply unit 400 and the first bubble extraction unit 770A and between the ink supply unit 400 and the second bubble extraction unit 770B.

The bubble retention chamber 520 and the bubble extraction unit 770 are not required to be arranged in both the supply flow path 130 and the first collecting flow path 140, but may be arranged only in the supply flow path 130 or only in the first collecting flow path 140. In addition, the bubble retention chamber 520 and the bubble extraction unit 770 may be arranged at three or more positions. The bubble retention chamber 520 and the bubble extraction unit 770 are also not required to be arranged in the supply flow path 130 and the first collecting flow path 140. For example, the bubble retention chamber 520 and the bubble extraction unit 770 may be arranged on the upper side in the vertical direction of the ink storage portion 2, the first supply path 111, the second supply path 112 and the third supply path 910. The bubble retention chamber 520 and the bubble extraction unit 770 may be arranged on an upper side in a vertical direction of the filter 110, the pump inlet flow path 170, the pump outlet flow path 180, the bypass flow path 160, the pressure chamber 12 and the like. In addition, the bubble retention chamber 520 and the bubble extraction unit 770 are not always required to be arranged on the upper side in the vertical direction of the communication portions of the supply flow path 130 and the like. As long as the configuration is such that the bubble can be trapped and brought into contact with the gas permeable membrane, the bubble retention chamber 520 may be formed so as to be in communication with the side surface of the communication portion, and the bubble extraction unit 770 may be formed so as to extend to the side of the bubble retention chamber 520. The same holds true for the case in which the bubble retention chambers 520 and the bubble extraction units 770 are arranged in a plurality of portions of the communication portions other than the supply flow path 130 and the first collecting flow path 140.

### (Ink)

The ink to be used in the recording method of the present disclosure is an aqueous ink for ink jet in which the surface tension γᵢ (mN/m) at 25° C. and the surface energy γₘ (mN/m) of the gas permeable membrane satisfy a relationship of the following formula (1). Each component to be used in the ink is described below in detail.

$${γ}_{i} - {γ}_{m} \leq 11 \qquad ( 1 )$$

### [Coloring Material]

The ink preferably includes the coloring material. A pigment or a dye may be used as the coloring material. The content (% by mass) of the coloring material in the ink is preferably 0.50% by mass or more to 15.00% by mass or less, more preferably 1.00% by mass or more to 10.00% by mass or less with respect to the total mass of the ink.

Specific examples of the pigment may include: inorganic pigments, such as carbon black and titanium oxide; and organic pigments, such as azo, phthalocyanine, quinacridone, isoindolinone, imidazolone, diketopyrrolopyrrole and dioxazine pigments. The pigments may be used alone or in combination thereof.

A resin-dispersed pigment using a resin as a dispersant, a self-dispersible pigment, which has a hydrophilic group bonded to its particle surface, or the like may be used as a dispersion system for the pigment. In addition, a resin-bonded pigment having a resin-containing organic group chemically bonded to its particle surface, a microcapsule pigment, which contains a particle whose surface is covered with, for example, a resin, or the like may be used. Pigments different from each other in dispersion system out of those pigments may be used in combination. In particular, it is preferable that a resin-dispersed pigment in which a resin serving as a dispersant is physically adsorbed to the surface of a pigment particle or a self-dispersible pigment in which an anionic group is bonded to the surface of a pigment particle directly or via another atomic group (—R—) be used instead of a resin-bonded pigment or a microcapsule pigment.

A dispersant that can disperse the pigment in an aqueous medium through the action of an anionic group is preferably used as a resin dispersant for dispersing the pigment in the aqueous medium. A resin having an anionic group may be used as the resin dispersant and such a resin as described later, in particular, a water-soluble resin is preferably used. The mass ratio of the content (% by mass) of the pigment in the ink to the content (% by mass) of the resin dispersant therein is preferably 0.3 times or more to 10.0 times or less.

A pigment having an anionic group, such as a carboxylic acid group, a sulfonic acid group or a phosphonic acid group, bonded to its particle surface directly or through any other atomic group (—R—) may be used as the self-dispersible pigment. The anionic group may be any one of an acid type or a salt type. When the group is a salt type, the group may be in any one of a state in which part of the group dissociates or a state in which the entirety thereof dissociates. When the anionic group is a salt type, examples of a cation serving as a counterion may include an alkali metal cation, ammonium and an organic ammonium. Specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

A dye having an anionic group is preferably used as the dye. Specific examples of the dye may include dyes, such as azo, triphenylmethane, (aza) phthalocyanine, xanthene and anthrapyridone dyes. The dyes may be used alone or in combination thereof. The coloring material is preferably a pigment, more preferably a resin-dispersed pigment in which a resin serving as a dispersant is physically adsorbed to the surface of a pigment particle or a self-dispersible pigment in which an anionic group is bonded to the surface of a pigment particle directly or via another atomic group (—R—).

### [Resin]

A resin can be incorporated into the ink. When the ink containing a resin is used, an image having improved abrasion resistance can be recorded. The resin may be added to the ink (i) in order to stabilize the dispersed state of a pigment, that is, as a resin dispersant or an assistant thereof, or (ii) in order to improve various characteristics of an image to be recorded.

The content (% by mass) of the resin in the ink is preferably 0.10% by mass or more to 20.00% by mass or less, more preferably 0.50% by mass or more to 15.00% by mass or less with respect to the total mass of the ink. Examples of the form of the resin may include a block copolymer, a random copolymer, a graft copolymer and a combination thereof. In addition, the resin may be a water-soluble resin that can be dissolved in an aqueous medium or a resin particle that is dispersed in an aqueous medium. The resin may be used alone or in combination of two or more kinds thereof.

### [Composition of Resin]

Examples of the resin may include an acrylic resin, a urethane-based resin, an olefin-based resin and a polyester-based resin. Of those, an acrylic resin and a urethane-based resin are preferable and an acrylic resin including a unit derived from (meth)acrylic acid or a (meth)acrylate is more preferable.

A resin having a hydrophilic unit and a hydrophobic unit as its structural units is preferable as the acrylic resin. Of those, a resin having a hydrophilic unit derived from (meth)acrylic acid and a hydrophobic unit derived from at least one of a monomer having an aromatic ring and a (meth)acrylic acid ester-based monomer is preferable. A resin having a hydrophilic unit derived from (meth)acrylic acid and a hydrophobic unit derived from at least one monomer of styrene and α-methylstyrene is particularly preferable. Those resins may each be suitably utilized as a resin dispersant for dispersing the pigment because the resins each easily cause an interaction with the pigment.

The hydrophilic unit is a unit having a hydrophilic group such as an anionic group. The hydrophilic unit may be formed by, for example, polymerizing a hydrophilic monomer having a hydrophilic group. Specific examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Specific examples of the hydrophobic monomer may include: monomers each having an aromatic ring, such as styrene, α-methylstyrene and benzyl (meth)acrylate; and (meth)acrylic acid ester-based monomers, such as methyl (meth)acrylate, ethyl (meth)acrylate, propyl (meth)acrylate, butyl (meth)acrylate, 2-ethylhexyl (meth)acrylate and cyclohexyl (meth)acrylate.

The urethane-based resin may be obtained by, for example, causing a polyisocyanate and a polyol to react with each other. In addition, a chain extender may be further caused to react with the reaction product. Examples of the olefin-based resin may include polyethylene and polypropylene. The polyester-based resin may be obtained, for example, by subjecting a polyvalent carboxylic acid and a polyol to dehydration condensation.

### [Properties of Resin]

The phrase “resin is water-soluble” as used herein means that when the resin is neutralized with an alkali whose amount is equivalent to its acid value, the resin is present in an aqueous medium under a state in which the resin does not form any particle whose particle diameter may be measured by a dynamic light scattering method. Whether or not the resin is water-soluble can be judged in accordance with the following method. First, a liquid (resin solid content: 10% by mass) containing the resin neutralized with an alkali (e.g., sodium hydroxide or potassium hydroxide) corresponding to its acid value is prepared. Next, the prepared liquid is diluted with pure water tenfold (on a volume basis) to prepare a sample solution. Then, when no particle having a particle diameter is measured at the time of the measurement of the particle diameter of the resin in the sample solution by the dynamic light scattering method, the resin can be judged to be water-soluble. Measurement conditions at this time may be set, for example, as follows: Set Zero: 30 seconds; number of times of measurement: 3; and measurement time: 180 seconds. In addition, a particle size analyzer based on the dynamic light scattering method (e.g., an analyzer available under the product name “UPA-EX150” from Nikkiso Co., Ltd.) or the like may be used as a particle size distribution measuring device. Of course, the particle size distribution measuring device to be used, the measurement conditions and the like are not limited to the foregoing.

The acid value of the water-soluble resin is preferably 100 mgKOH/g or more to 250 mgKOH/g or less. The weight-average molecular weight of the water-soluble resin is preferably 3,000 or more to 15,000 or less. The acid value of the resin for forming the resin particle is preferably 5 mgKOH/g or more to 100 mgKOH/g or less. The weight-average molecular weight of the resin for forming the resin particle is preferably 1,000 or more to 3,000,000 or less, more preferably 100,000 or more to 3,000,000 or less. The volume-based cumulative 50% particle diameter (D₅₀) of the resin particle measured by a dynamic light scattering method is preferably 50 nm or more to 500 nm or less. The volume-based cumulative 50% particle diameter of the resin particle is the diameter of a particle that is 50% integrated from the smallest particle diameter side based on the total volume of the measured particles in the particle diameter integration curve. The volume-based cumulative 50% particle diameter of the resin particle may be measured with a particle size analyzer of a dynamic light scattering system under the measurement conditions as described above. The glass transition temperature of the resin particle is preferably 40° C. or more to 120° C. or less, more preferably 50° C. or more to 100° C. or less. The glass transition temperature (° C.) of the resin particle may be measured with a differential scanning calorimeter (DSC). The resin particle is not required to encapsulate the coloring material.

### [Aqueous Medium]

The ink to be used in the recording method of the present disclosure is an aqueous ink including at least water as an aqueous medium. An aqueous medium that is the water or a mixed solvent of the water and a water-soluble organic solvent may be incorporated into the ink. Deionized water or ion-exchanged water is preferably used as the water. The content (% by mass) of the water in the aqueous ink is preferably 50.00% by mass or more to 95.00% by mass or less with respect to the total mass of the ink. In addition, the content (% by mass) of the water-soluble organic solvent in the aqueous ink is preferably 2.00% by mass or more to 40.00% by mass or less with respect to the total mass of the ink. Solvents that may be used in an ink for ink jet, such as alcohols, (poly)alkylene glycols, glycol ethers, nitrogen-containing solvents and sulfur-containing solvents, may each be used as the water-soluble organic solvent. The water-soluble organic solvents may be used alone or in combination thereof.

When the ink contains the water-soluble organic solvent, the average SP value of the water-soluble organic solvent in the ink is preferably 15.0 (cal/cm³)^{1/2} or less because the ejection stability can be further improved. The average SP value of the water-soluble organic solvent in the ink is more preferably 8.0 (cal/cm³)^{1/2} or more, particularly preferably 12.0 (cal/cm³)^{1/2} or more.

When the material of the gas permeable membrane is a resin, the difference between the average SP value of the water-soluble organic solvent in the ink and the SP value of the resin for forming the gas permeable membrane is preferably 6.5 (cal/cm³)^{1/2} or less because the ejection stability can be further improved. In particular, the difference is more preferably 6.0 (cal/cm³)^{1/2} or less. In addition, the difference is more preferably 3.0 (cal/cm³)^{1/2} or more.

The SP value (δ: solubility parameter) as used herein is a value (unit: (cal/cm³)^{1/2}) calculated by the Fedors method based on the following equation (A). When the SP value is converted into International System of Units, the relationship of “(cal/cm³)^{1/2}=2.046×10³ (J/m³)^{1/2}” may be used. The ΔEᵥₐₚ and V of the resin may be determined, for example, with reference to the description of Coating Jiho No. 193 (1992) or the like.

$$δ = {( Δ {E}_{vap} / V )}^{1 / 2} \qquad ( A )$$

In the equation (A), ΔEᵥₐₚ represents the molar heat of vaporization (cal/mol) of a compound, and V represents the molar volume (cm³/mol) of the compound at 25° C.

The aqueous ink for ink jet generally contains a plurality of kinds of water-soluble organic solvents. Thus, the SP value of the water-soluble organic solvent in the ink is suitable for being expressed using the concept of the “average SP value”. The term “average SP value” means a value obtained by calculating a value, which is obtained by multiplying the SP value specific to a water-soluble organic solvent by the ratio (% by mass) of the water-soluble organic solvent accounting for the total amount of water-soluble organic solvents in the ink, for each of the water-soluble organic solvents and integrating the resultant values. When there is only one kind of water-soluble organic solvent in the ink, the SP value of the water-soluble organic solvent is the “average SP value”.

For example, in the case of “Ink 1” prepared in “Examples” described later, the compositions of the water-soluble organic solvents (total: 20.0 parts by mass) are as described below. The numerical values in parentheses are the SP values (units are omitted) of the respective water-soluble organic solvents. The average SP value of the water-soluble organic solvents in the “Ink 1” may be calculated by the following equation (B).
Glycerin (16.4): 10.00 parts by mass (% by mass)·
Polyethylene glycol having a number-average molecular weight of 600 (10.5): 10.00 parts by mass (% by mass)

$$Average SP value = ( 16.4 \times 10 \text{.00} / 20. ) + ( 10.5 \times 10 \text{.00} / 20. ) = 13.5 \qquad ( B )$$

The SP values based on the Fedors method of water-soluble organic solvents that are commonly used for an aqueous ink for ink jet are described below with the unit (cal/cm³)^{1/2} being omitted. Glycerin (16.4), 1,3-propanediol (16.1), trimethylolpropane (15.9), 1,4-butanediol (15.0), diethylene glycol (15.0), ethylene glycol (14.8), 1,3-butanediol (14.8), 2-methyl-1,3-propanediol (14.8), 1,2,6-hexanetriol (14.5), urea (14.4), ethylene urea (14.2), 1,5-pentanediol (14.2), triethanolamine (13.7), methanol (13.8), triethylene glycol (13.6), 1,6-hexanediol (13.5), 3-methyl-1,5-pentanediol (13.4), tetraethylene glycol (12.8), polyethylene glycol having a number-average molecular weight of 200 (12.8), 2-pyrrolidone (12.6), ethanol (12.6), 1,2-pentanediol (12.2), ethylene glycol monomethyl ether (12.0), n-propanol (11.8), 1,2-hexanediol (11.8), isopropanol (11.6), N-methyl-2-pyrrolidone (11.5), ethylene glycol monoethyl ether (12.0), 1,3-dimethyl-2-imidazolidinone (11.4), n-butanol (11.3), diethylene glycol monomethyl ether (11.2), 2-butanol (11.1), isobutanol (11.1), diethylene glycol monoethyl ether (10.9), tert-butanol (10.9), triethylene glycol monoethyl ether (10.6), polyethylene glycol having a number-average molecular weight of 600 (10.5), diethylene glycol monobutyl ether (10.5), triethylene glycol monobutyl ether (10.3), tetraethylene glycol monobutyl ether (10.2), polyethylene glycol having a number-average molecular weight of 1,000 (10.1), acetone (9.1), methyl ethyl ketone (9.0), tetraethylene glycol dimethyl ether (8.5), triethylene glycol butyl methyl ether (8.4) and ethylene glycol dimethyl ether (7.6). The SP value of the water-soluble organic solvent is preferably 5.0 (cal/cm³)^{1/2} or more to 15.0 (cal/cm³)^{1/2} or less.

The water-soluble organic solvent is preferably a compound having an alkylene oxide structure. In addition, the ink preferably contains a nonionic surfactant in addition to the compound having an alkylene oxide structure serving as the water-soluble organic solvent. The compound having an alkylene oxide structure has high affinity for a nonionic surfactant having a hydroxyl group or an alkylene oxide structure. Thus, when the nonionic surfactant and the compound having an alkylene oxide structure are used together, the nonionic surfactant and the compound are easily mixed well with each other. As a result, the wettability of the ink to the gas permeable membrane can be further improved, and the ejection stability can be further improved. Examples of the alkylene oxide structure may include ethylene oxide (—CH₂—CH₂—O—) and propylene oxide (—CH₂—CH(CH₃)—O—), and ethylene oxide is particularly preferable.

Although the term “water-soluble organic solvent” generally means a liquid, in the present disclosure, the water-soluble organic solvent encompasses a compound that is solid at 25° C. (normal temperature). Examples of the water-soluble organic solvent which is commonly used for an aqueous ink and which is solid at 25° C. include 1,6-hexanediol, trimethylolpropane, ethylene urea, urea and polyethylene glycol having a number-average molecular weight of 1,000.

### [Surfactant]

The ink preferably contains a surfactant. Examples of the surfactant may include a cationic surfactant, an anionic surfactant, an amphoteric surfactant and a nonionic surfactant. Of those, the nonionic surfactant having an HLB value of 12 or less is preferably used because the wettability of the ink to the gas permeable membrane can be further increased, and hence the ejection stability can be further improved.

Examples of the nonionic surfactant may include a hydrocarbon-based nonionic surfactant, a fluorine-based nonionic surfactant and a silicone-based nonionic surfactant. Of those, the nonionic surfactant is preferably the hydrocarbon-based nonionic surfactant and is more preferably an acetylene glycol-based surfactant because the ejection stability can be further improved. The “HLB value” of the surfactant as used herein is a value determined by the Griffin's method and is calculated based on an equation of HLB value=20× (formula weight of hydrophilic group of surfactant)/(molecular weight of surfactant). The HLB value determined by the Griffin's method is a physical property value indicating the degree of hydrophilicity and lipophilicity of the surfactant and takes a value of from 0 to 20. When the HLB value is smaller, the lipophilicity is higher. When the HLB value is larger, the hydrophilicity is higher. The HLB value of the surfactant is preferably 4 or more.

The content (% by mass) of the surfactant in the ink is preferably 0.10% by mass or more to 5.00% by mass or less, more preferably 0.30% by mass or more to 1.50% by mass or less based on the total mass of the ink. In addition, two or more kinds of surfactants may be added to the ink. When surfactants having different characteristics are added, the wettability of the ink to the gas permeable membrane can be further improved.

### [Other Component]

The ink may include various other components (additives) as required. Examples of other components may include various additives, such as an antifoaming agent, a pH adjustor, a viscosity modifier, a rust inhibitor, an antiseptic, a fungicide, an antioxidant and an anti-reducing agent. In the present disclosure, the contents of those additives (including surfactants) are small, and the influence thereof on the effects of the present disclosure is relatively small. Thus, those additives are not included in the calculation of the SP value.

### [Ink Physical Properties]

The surface tension γᵢ of the ink at 25° C. is preferably 40 mN/m or less, more preferably 25 mN/m or more to 35 mN/m or less. When the surface tension γᵢ of the ink is more than 40 mN/m, the bubble extraction property may be easily decreased due to a decrease in the wettability to the gas permeable membrane, and the effect of improving the ejection stability of the ink may be decreased. In addition, when the value of the surface tension of the ink is closer to the value of the surface energy of the gas permeable membrane, the wettability of the ink to the gas permeable membrane is increased, and hence the bubble extraction property is further improved. The surface tension γᵢ (mN/m) of the ink as used herein is the “static surface tension” measured by the plate method under a temperature condition of 25° C. The surface tension of the ink may be adjusted, for example, through use of a surfactant or a water-soluble organic solvent.

The viscosity of the ink at 25° C. is preferably 1.0 mPa's or more to 10.0 mPa's or less. The viscosity of the ink at 25° C. may be measured with a rotary viscometer. The pH of the ink at 25° C. is preferably 7.0 or more to 9.0 or less. The pH of the ink may be measured with a general pH meter having a glass electrode or the like mounted thereon.

### EXAMPLES

The present disclosure is described in more detail below by way of Examples and Comparative Examples. The present disclosure is by no means limited to Examples below without departing from the gist of the present disclosure. “Part(s)” and “%” with regard to the description of the amounts of components are by mass unless otherwise stated.

### <Preparation of Pigment Dispersion Liquid>

### (Pigment Dispersion Liquid 1)

15.0 Parts of a pigment, 15.0 parts of an aqueous solution of a resin dispersant and 70.0 parts of water were mixed and dispersed with a sand grinder for 1 hour. After that, a non-dispersed substance containing a coarse particle was removed by centrifugation. As the pigment, carbon black (product name “Printex 85”, manufactured by Orion Engineered Carbons) was used. As the aqueous solution of the resin dispersant, an aqueous solution having a content of a resin (solid content) of 20.0%, which was obtained by neutralizing a styrene-acrylic acid copolymer with a 10% potassium hydroxide aqueous solution in an amount equimolar to an acid value and adding an appropriate amount of ion-exchanged water, was used. The acid value of the styrene-acrylic acid copolymer was 150 mgKOH/g, and the weight-average molecular weight thereof was 8,000. After the resultant was filtered under pressure through a microfilter (manufactured by FUJIFILM Corporation) having a pore size of 3.0 μm, an appropriate amount of ion-exchanged water was added to prepare a pigment dispersion liquid 1. The content of the pigment in the pigment dispersion liquid 1 was 15.00%, and the content of the resin in the pigment dispersion liquid 1 was 3.00%.

### (Pigment Dispersion Liquid 2)

A pigment dispersion liquid 2 was obtained in the same manner as in the case of the above-mentioned pigment dispersion liquid 1 except that C.I. Pigment Blue 15:3 was used as the pigment. The content of the pigment in the resultant pigment dispersion liquid 2 was 15.00%, and the content of the resin in the resultant pigment dispersion liquid 2 was 3.00%.

### (Pigment Dispersion Liquid 3)

A pigment dispersion liquid 3 was obtained in the same manner as in the case of the above-mentioned pigment dispersion liquid 1 except that C.I. Pigment Red 122 was used as the pigment. The content of the pigment in the resultant pigment dispersion liquid 3 was 15.00%, and the content of the resin in the resultant pigment dispersion liquid 3 was 3.00%.

### (Pigment Dispersion Liquid 4)

A pigment dispersion liquid 4 was obtained in the same manner as in the case of the above-mentioned pigment dispersion liquid 1 except that C.I. Pigment Yellow 74 was used as the pigment. The content of the pigment in the resultant pigment dispersion liquid 4 was 15.00%, and the content of the resin in the resultant pigment dispersion liquid 4 was 3.00%.

### (Pigment Dispersion Liquid 5)

A water dispersion liquid (product name “Cab-O-Jet 300”, manufactured by Cabot Corporation) containing a self-dispersible pigment in which a benzene carboxylic acid group was bonded to the particle surface of carbon black was used as a pigment dispersion liquid 5. The content of the pigment in the pigment dispersion liquid 5 was 15.00%.

### <Preparation of Surfactant>

Surfactants of the kinds shown in Table 1 were prepared.

TABLE 1
Characteristics of surfactant

| | | | | HLB |
|---|---|---|---|---|
| Surfactant | Kind | Structure | Manufacturer | value |
| 1 | Acetylenol | Acetylene glycol | Kawaken Fine | 11 |
| | E60 | based | Chemicals Co., | |
| | | | Ltd. | |
| 2 | SURFYNOL | Acetylene glycol | Nissin Chemical | 4 |
| | 420 | based | Co., Ltd. | |
| 3 | NIKKOL BB- | Polyoxyethylene | Nikko Chemicals | 12 |
| | 10 | behenyl ether | Co., Ltd. | |
| 4 | Acetylenol | Acetylene glycol | Kawaken Fine | 13 |
| | E100 | based | Chemicals Co., | |
| | | | Ltd. | |
| 5 | NEWPOL | Polyoxyethylene | Sanyo Chemical | 5 |
| | PE-62 | polyoxypropylene | Industries, Ltd. | |
| | | block polymer | | |

### <Preparation of Ink>

Respective components (unit: %) shown in the middle section of Table 2 (Table 2-1 to Table 2-3) were mixed and thoroughly stirred. After that, the mixture was filtered under pressure with a cellulose acetate filter (manufactured by ADVANTEC) having a pore size of 3.0 μm to prepare each ink. In Table 2, the numerical values in parentheses for the water-soluble organic solvents are SP values ((cal/cm³)^{1/2}) of the water-soluble organic solvents. The physical properties and the like of each of the prepared inks are shown in the lower section of Table 2.

TABLE 2-1
Composition and characteristics of ink

| | Ink | | | | | | | |
|---|---|---|---|---|---|---|---|---|
| | 1 | 2 | 3 | 4 | 5 | 6 | 7 | 8 |
| Kind of pigment dispersion | 1 | 2 | 3 | 4 | 5 | 1 | 1 | 1 |
| liquid | | | | | | | | |
| Kind of surfactant | 1 | 1 | 1 | 1 | 1 | 1 | 1 | 1 |
| Pigment dispersion liquid | 40.00 | 40.00 | 40.00 | 40.00 | 40.00 | 40.00 | 40.00 | 40.00 |
| Surfactant | 1.00 | 1.00 | 1.00 | 1.00 | 1.00 | 1.00 | 1.00 | 1.00 |
| Glycerin (16.4) | 10.00 | 10.00 | 10.00 | 10.00 | 10.00 | 10.00 | 10.00 | 10.00 |
| Triethylene glycol (13.6) | | | | | | | | |
| 1,6-hexanediol (13.5) | | | | | | 5.00 | | |
| 1,2-butanediol (12.8) | | | | | | | 5.00 | |
| 2-pyrrolidone (12.6) | | | | | | | | |
| 1,2-hexanediol (11.8) | | | | | | | | |
| Polyethylene glycol | 10.00 | 10.00 | 10.00 | 10.00 | 10.00 | 5.00 | 5.00 | 5.00 |
| (number-average molecular | | | | | | | | |
| weight of 600) (10.5) | | | | | | | | |
| Triethylene glycol monobutyl | | | | | | | | 5.00 |
| ether (10.3) | | | | | | | | |
| 2-(2-isobutoxyethoxy)ethanol | | | | | | | | |
| (8.3) | | | | | | | | |
| Ion-exchanged water | 39.00 | 39.00 | 39.00 | 39.00 | 39.00 | 39.00 | 39.00 | 39.00 |
| Content of pigment (%) | 6.00 | 6.00 | 6.00 | 6.00 | 6.00 | 6.00 | 6.00 | 6.00 |
| Surface tension γᵢ (mN/m) | 30 | 30 | 30 | 30 | 30 | 30 | 30 | 30 |
| Average SP value of water- | 13.5 | 13.5 | 13.5 | 13.5 | 13.5 | 14.2 | 14.0 | 13.4 |
| soluble organic solvent | | | | | | | | |
| ((cal/cm³)^{1/2}) | | | | | | | | |

TABLE 2-2

| | Ink | | | | | | | |
|---|---|---|---|---|---|---|---|---|
| | 9 | 10 | 11 | 12 | 13 | 14 | 15 | 16 |
| Kind of pigment dispersion | 1 | 1 | 1 | 1 | 1 | 1 | 1 | 1 |
| liquid | | | | | | | | |
| Kind of surfactant | 1 + 2 | 1 | 1 | 1 | 1 | 1 | 1 | 1 |
| Pigment dispersion liquid | 40.00 | 40.00 | 40.00 | 40.00 | 40.00 | 40.00 | 40.00 | 40.00 |
| Surfactant | 0.50 | 0.75 | 1.00 | 0.05 | 0.03 | 1.00 | 1.00 | 1.00 |
| | 0.25 | | | | | | | |
| Glycerin (16.4) | 10.00 | 7.00 | 10.00 | 10.00 | 10.00 | | 10.00 | 10.00 |
| Triethylene glycol (13.6) | | | | | | | 10.00 | 8.00 |
| 1,6-hexanediol (13.5) | | | | | | | | |
| 1,2-butanediol (12.8) | | | | | | | | |
| 2-pyrrolidone (12.6) | | | | | | | | |
| 1,2-hexanediol (11.8) | | | 5.00 | | | | | |
| Polyethylene glycol | 10.00 | 10.00 | 5.00 | 10.00 | 10.00 | 10.00 | | |
| (number-average molecular | | | | | | | | |
| weight of 600) (10.5) | | | | | | | | |
| Triethylene glycol monobutyl | | | | | | | | |
| ether (10.3) | | | | | | | | |
| 2-(2-isobutoxyethoxy)ethanol | | | | | | | | |
| (8.3) | | | | | | | | |
| Ion-exchanged water | 39.25 | 42.25 | 39.00 | 39.95 | 39.97 | 49.00 | 39.00 | 41.00 |
| Content of pigment (%) | 6.00 | 6.00 | 6.00 | 6.00 | 6.00 | 6.00 | 6.00 | 6.00 |
| Surface tension γᵢ (mN/m) | 30 | 35 | 25 | 40 | 45 | 30 | 30 | 30 |
| Average SP value of water- | 13.5 | 12.9 | 13.8 | 13.5 | 13.5 | 10.5 | 15.0 | 15.2 |
| soluble organic solvent | | | | | | | | |
| ((cal/cm³)^{1/2}) | | | | | | | | |

TABLE 2-3

| | Ink | | | | | | | | |
|---|---|---|---|---|---|---|---|---|---|
| | 17 | 18 | 19 | 20 | 21 | 22 | 23 | 24 | 25 |
| Kind of pigment | 1 | 1 | 1 | 1 | 1 | 1 | 1 | 1 | 1 |
| dispersion liquid | | | | | | | | | |
| Kind of surfactant | 1 | 1 | 1 | 2 | 3 | 4 | 5 | 1 | 1 |
| Pigment dispersion | 40.00 | 40.00 | 40.00 | 40.00 | 40.00 | 40.00 | 40.00 | 40.00 | 40.00 |
| liquid | | | | | | | | | |
| Surfactant | 1.00 | 1.00 | 1.00 | 0.50 | 1.00 | 1.00 | 0.50 | 1.00 | 0.05 |
| Glycerin (16.4) | | 5.00 | 8.00 | 10.00 | 10.00 | 10.00 | 10.00 | | 7.00 |
| Triethylene glycol (13.6) | | 10.00 | 10.00 | | | | | | |
| 1,6-hexanediol (13.5) | | | | | | | | | |
| 1,2-butanediol (12.8) | | | | | | | | | |
| 2-pyrrolidone (12.6) | | | | | | | | 10.00 | |
| 1,2-hexanediol (11.8) | | | | | | | | | |
| Polyethylene glycol | 6.00 | | | 10.00 | 10.00 | 10.00 | 10.00 | | 10.00 |
| (number-average | | | | | | | | | |
| molecular weight of 600) | | | | | | | | | |
| (10.5) | | | | | | | | | |
| Triethylene glycol | | | | | | | | | |
| monobutyl ether (10.3) | | | | | | | | | |
| 2-(2- | 10.00 | | | | | | | | |
| isobutoxyethoxy)ethanol | | | | | | | | | |
| (8.3) | | | | | | | | | |
| Ion-exchanged water | 43.00 | 44.00 | 41.00 | 39.50 | 39.00 | 39.00 | 39.50 | 49.00 | 42.95 |
| Content of pigment (%) | 6.00 | 6.00 | 6.00 | 6.00 | 6.00 | 6.00 | 6.00 | 6.00 | 6.00 |
| Surface tension γᵢ (mN/m) | 30 | 30 | 30 | 30 | 30 | 30 | 30 | 30 | 40 |
| Average SP value of | 9.1 | 14.5 | 14.8 | 13.5 | 13.5 | 13.5 | 13.5 | 12.6 | 12.9 |
| water-soluble organic | | | | | | | | | |
| solvent ((cal/cm³)^{1/2}) | | | | | | | | | |

### <Recording Head>

Recording heads having configurations shown in Table 3 were produced. The abbreviations in Table 3 indicate PP: polypropylene, FEP: fluoroethylene-hexafluoropropylene copolymer, PE: polyethylene and PS: polystyrene.

TABLE 3
Configuration of recording head

| | | | Gas permeable membrane | | | | |
|---|---|---|---|---|---|---|---|
| | Liquid | | | | Surface | | |
| Recording | retention | Decompression | | | energy | SP value | Thickness |
| head | chamber | chamber | Membrane | Material | (mN/m) | ((cal/cm³)^{1/2}) | (mm) |
| 1 | Present | Present | Present | PP | 29 | 8.0 | 0.05 |
| 2 | Present | Present | Present | PP | 29 | 8.0 | 0.010 |
| 3 | Present | Present | Present | FEP | 24 | 6.6 | 0.05 |
| 4 | Present | Present | Present | PE | 35 | 8.6 | 0.05 |
| 5 | Present | Present | Present | PS | 40 | 9.0 | 0.05 |
| 6 | Present | Present | Present | PP | 29 | 8.0 | 0.10 |
| 7 | Present | Present | Present | PP | 29 | 8.0 | 0.20 |
| 8 | Present | Present | Absent | — | — | — | — |
| 9 | Present | Present | Present | PP | 29 | 8.0 | 0.009 |
| 10 | Present | Absent | Absent | — | — | — | — |
| 11 | Present | Present | Present | FEP *¹ | 24 *¹ | 6.6 *¹ | 0.002 *¹ |
| 12 | Present | Present | Absent | PP *² | 29 *² | 8.0 *² | 1.00 *² |

* Regarding the recording head 11, the material and thickness of a “hollow fiber membrane” are shown.
* Regarding the recording head 12, the material and thickness of a “gas permeable partition wall” are shown.

### <Evaluation>

An ink jet recording apparatus (product name “GX6030”, manufactured by CANON KABUSHIKI KAISHA) in which each of recording heads of the kinds shown in Table 4 was incorporated was prepared. In Examples, the recording duty of a solid image recorded under such a condition that two ink droplets having a mass of 11.7 ng±10% per droplet are applied to a unit region measuring 1/600 inch by 1/600 inch is defined as 100%. Each of the prepared inks was filled into an ink cartridge and set in the ink jet recording apparatus so as to achieve a combination of the recording head and the ink shown in Table 4. Then, evaluation of each of the following items was performed. In the present disclosure, in the following evaluation criteria of each of the items, the levels “AA”, “A” and “B” were defined as acceptable levels, and the level “C” was defined as an unacceptable level. The evaluation results are shown in Table 4.

In Comparative Example 4, an ink jet recording apparatus having a deaeration unit including a hollow fiber module arranged in a path for supplying an ink from an ink storage portion to a recording head was used with reference to the description in Japanese Patent Laid-Open No. 2015-058544. In Reference Example 1, an ink jet recording apparatus having a filter for trapping a bubble, which is arranged in a path for supplying an ink from an ink storage portion to a recording head, was used with reference to the description in Japanese Patent Laid-Open No. 2013-223980. In Reference Example 2, an ink jet recording apparatus having a deaerator including a partition formed of a hollow fiber membrane arranged inside a recording head was used with reference to the description in Japanese Patent Laid-Open No. 2011-173428. In Reference Example 3, an ink jet recording apparatus having a gas permeable partition wall having a thickness of 1.00 mm arranged inside a recording head instead of a gas permeable membrane was used with reference to the description in Japanese Patent Laid-Open No. 2008-173961.

### (Ejection Stability)

In order to reproduce the state obtained after the recording apparatus was left for a certain period of time, 0.3 mL of air was injected into the liquid retention chamber. The volume of the bubble retention chamber in the liquid retention chamber is 0.5 mL. The decompression chamber was decompressed at the decompression degree shown in Table 4 for 5 days, and the air in the liquid retention chamber was transferred to the decompression chamber through the gas permeable membrane. After that, a bubble was discharged from the ejection orifice by performing a normal suction recovery operation with a printer driver. Then, a solid image having a recording duty of 100% was recorded onto an entire surface of 200 sheets of an A4 size recording medium. When decompression was not performed, the evaluation was performed in the same procedure except that, after 0.3 mL of air was injected into the liquid retention chamber, the apparatus was left to stand still for 5 days. As the recording medium, plain paper (product name “CS-068 A4”, manufactured by CANON KABUSHIKI KAISHA) was used. The recorded image was visually checked to evaluate the ejection stability of the ink in accordance with the following evaluation criteria.
AA: The ratio of an area in which non-ejection had occurred was 0%.
A: The ratio of an area in which non-ejection had occurred was more than 0% to less than 5%.
B: The ratio of an area in which non-ejection had occurred was 5% or more to less than 10%.
C: The ratio of an area in which non-ejection had occurred was 10% or more.

### (Suction Recoverability)

The cycle involving performing the normal suction operation from the ejection orifice and the recording of a solid image having a recording duty of 100% on an entire surface of an A4 size recording medium after an elapse of 5 days from filling of an ink in the same procedure as that in the evaluation of the ejection stability was repeated until an image having no defects was recorded. As the recording medium, plain paper (product name “CS-068 A4”, manufactured by CANON KABUSHIKI KAISHA) was used. Then, the suction recoverability was evaluated in accordance with the following evaluation criteria.
A: Defects disappeared in a solid image and non-ejection stopped occurring, with one suction operation.
C: Defects disappeared in a solid image and non-ejection stopped occurring, with two or more suction operations.

TABLE 4
Evaluation conditions and evaluation results

| | | Evaluation conditions | | | | | | |
|---|---|---|---|---|---|---|---|---|
| | | | | Decompression | | Difference | Evaluation results | |
| | | Recording | | degree | γᵢ − γₘ | of SP value* | Ejection | Suction |
| | | head | Ink | (kPa) | (mN/m) | ((cal/cm³)^{1/2}) | stability | recoverability |
| Example | 1 | 1 | 1 | 50 | 1 | 5.5 | AA | A |
| | 2 | 1 | 2 | 50 | 1 | 5.5 | AA | A |
| | 3 | 1 | 3 | 50 | 1 | 5.5 | AA | A |
| | 4 | 1 | 4 | 50 | 1 | 5.5 | AA | A |
| | 5 | 1 | 5 | 50 | 1 | 5.5 | AA | A |
| | 6 | 1 | 6 | 50 | 1 | 6.2 | AA | A |
| | 7 | 1 | 7 | 50 | 1 | 6.0 | AA | A |
| | 8 | 1 | 8 | 50 | 1 | 5.4 | AA | A |
| | 9 | 1 | 9 | 50 | 1 | 5.5 | AA | A |
| | 10 | 2 | 1 | 50 | 1 | 5.5 | AA | A |
| | 11 | 3 | 10 | 50 | 11 | 6.3 | A | A |
| | 12 | 1 | 11 | 50 | −4 | 5.8 | AA | A |
| | 13 | 4 | 12 | 50 | 5 | 4.9 | A | A |
| | 14 | 4 | 13 | 50 | 10 | 4.9 | B | A |
| | 15 | 1 | 14 | 50 | 1 | 2.5 | AA | A |
| | 16 | 5 | 15 | 50 | −10 | 6.0 | A | A |
| | 17 | 5 | 16 | 50 | −10 | 6.2 | B | A |
| | 18 | 5 | 17 | 50 | −10 | 0.1 | A | A |
| | 19 | 1 | 18 | 50 | 1 | 6.5 | AA | A |
| | 20 | 1 | 19 | 50 | 1 | 6.8 | A | A |
| | 21 | 1 | 20 | 50 | 1 | 5.5 | AA | A |
| | 22 | 1 | 21 | 50 | 1 | 5.5 | A | A |
| | 23 | 1 | 22 | 50 | 1 | 5.5 | A | A |
| | 24 | 1 | 23 | 50 | 1 | 5.5 | A | A |
| | 25 | 1 | 24 | 50 | 1 | 4.6 | A | A |
| | 26 | 6 | 1 | 50 | 1 | 5.5 | AA | A |
| | 27 | 7 | 1 | 50 | 1 | 5.5 | A | A |
| | 28 | 5 | 1 | 50 | −10 | 4.5 | A | A |
| | 29 | 4 | 1 | 50 | −5 | 4.9 | A | A |
| | 30 | 1 | 1 | 8 | 1 | 5.5 | A | A |
| | 31 | 1 | 1 | 10 | 1 | 5.5 | AA | A |
| | 32 | 1 | 1 | 70 | 1 | 5.5 | AA | A |
| Comparative | 1 | 8 | 1 | 50 | — | — | C | A |
| Example | 2 | 9 | 1 | 50 | 1 | 5.5 | C | A |
| | 3 | 3 | 25 | 50 | 16 | 6.3 | C | A |
| | 4 | 10 | 1 | — | — | — | C | A |
| Reference | 1 | 10 | 1 | — | — | — | AA | A |
| Example | 2 | 11 | 1 | 3 | 6 | 6.9 | C | A |
| | 3 | 12 | 1 | 30 | 1 | 5.5 | C | A |
| | 4 | 10 | 1 | — | — | — | — | C |
| | 5 | 10 | 13 | — | — | — | — | C |

*Difference between the average SP value of the water-soluble organic solvent and the SP value of the resin for forming the gas permeable membrane

In Reference Example 1, the ejection stability and suction recoverability were excellent, but the apparatus was increased in size.

According to the present disclosure, the ink jet recording method excellent in suction recoverability and ejection stability of an ink can be provided. In addition, according to the present disclosure, the ink jet recording apparatus to be used in the ink jet recording method can be provided.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-124151, filed Jul. 31, 2024, Japanese Patent Application No. 2024-124152, filed Jul. 31, 2024, and Japanese Patent Application No. 2025-100390, filed Jun. 16, 2025, which are hereby incorporated by reference herein in their entirety.

What is claimed is:

1. An ink jet recording method of recording an image through use of an ink jet recording apparatus comprising a recording head,
the recording head comprising:
an ejection orifice configured to eject an aqueous ink;
a pressure chamber in communication with the ejection orifice;
an ejection element, which is arranged in the pressure chamber, and which is configured to generate energy for ejecting the aqueous ink from the ejection orifice;
a liquid retention chamber configured to supply the aqueous ink to the pressure chamber;
a decompression chamber, which is arranged adjacent to the liquid retention chamber, and which is configured to decompress an inside of the liquid retention chamber; and
a gas permeable membrane having a thickness of 0.01 mm or more and arranged at a boundary between the liquid retention chamber and the decompression chamber,
the ink jet recording method comprising applying the aqueous ink ejected from the ejection orifice to a recording medium,
wherein a surface tension γᵢ (mN/m) of the aqueous ink at 25° C. and a surface energy γₘ (mN/m) of the gas permeable membrane satisfy a relationship of the following formula (1),
$${γ}_{i} - {γ}_{m} \leq 11. \qquad ( 1 )$$

2. The ink jet recording method according to claim 1, wherein the surface tension γᵢ of the aqueous ink at 25° C. is 40 mN/m or less.

3. The ink jet recording method according to claim 1,
wherein the aqueous ink comprises a water-soluble organic solvent, and
wherein the water-soluble organic solvent has an average SP value of 15.0 (cal/cm³)^{1/2} or less.

4. The ink jet recording method according to claim 3,
wherein a material of the gas permeable membrane is a resin, and
wherein a difference between the average SP value of the water-soluble organic solvent and an SP value of the resin is 6.5 (cal/cm³)^{1/2} or less.

5. The ink jet recording method according to claim 1,
wherein the aqueous ink comprises a surfactant, and
wherein the surfactant has an HLB value of 12 or less.

6. The ink jet recording method according to claim 5, wherein the surfactant is an acetylene glycol-based surfactant.

7. The ink jet recording method according to claim 3, wherein the water-soluble organic solvent comprises a compound having an alkylene oxide structure.

8. The ink jet recording method according to claim 1, wherein the gas permeable membrane has a thickness of 0.10 mm or less.

9. The ink jet recording method according to claim 1, wherein a material of the gas permeable membrane is one of polypropylene or polyethylene.

10. The ink jet recording method according to claim 1, wherein a material of the gas permeable membrane is polypropylene.

11. The ink jet recording method according to claim 1, wherein the decompression chamber has a decompression degree of 10 kPa or more.

12. An ink jet recording apparatus comprising a recording head,
the recording head comprising:
an ejection orifice configured to eject an aqueous ink;
a pressure chamber in communication with the ejection orifice;
an ejection element, which is arranged in the pressure chamber, and which is configured to generate energy for ejecting the aqueous ink from the ejection orifice;
a liquid retention chamber configured to supply the aqueous ink to the pressure chamber;
a decompression chamber, which is arranged adjacent to the liquid retention chamber, and which is configured to decompress an inside of the liquid retention chamber; and
a gas permeable membrane having a thickness of 0.01 mm or more and arranged at a boundary between the liquid retention chamber and the decompression chamber,
wherein a surface tension γᵢ (mN/m) of the aqueous ink at 25° C. and a surface energy γₘ (mN/m) of the gas permeable membrane satisfy a relationship of the following formula (1),
$${γ}_{i} - {γ}_{m} \leq 11. \qquad ( 1 )$$
